(19) United States
(12) Patent Application Publication
(10) Pub. No.: US 2007/0031865 A1
(43) Pub. Date: Feb. 8, 2007

(54) Novel Process for Construction of a DNA Library

(76) Inventor: David Willoughby, Jupiter, FL (US)

Correspondence Address: ROGERS IP GROUP, 2901 NORTH DALE MABRY HWY, # 2404, TAMPA, FL, 33607, US

(21) Appl. No.: 11/456,082

(22) Filed: Jul. 6, 2006

Related U.S. Application Data
(60) Provisional application No. 60/595,470, filed on Jul. 7, 2005.

(51) Int. Cl. C40B 30/06; C40B 40/08

(52) U.S. Cl. 435/6

(57) ABSTRACT

The invention is directed to processes for constructing DNA Libraries in which ssDNA containing a chemical modification (CM) at or near the 5′- or 3′-terminus is prepared from a RNA or DNA source, a 1^{st} universal oligonucleotide (Oligo A′) is ligated to the 3′-of the ssDNA, and a 2^{nd} universal oligonucleotide (Oligo B) is ligated to the 5′-terminus of the ssDNA. Chemical modifications useful for the process are functional groups capable of binding a solid support with high affinity, or functional groups that can mediate a non-enzymatic ligation. In one embodiment of the invention, a CM at or near the 5′-terminus of the ssDNA mediates binding of the ssDNA to a solid support, allowing removal of residual unligated Oligo A′ prior to ligation of Oligo B. In another embodiment of the invention, a CM at or near the 5′-terminus of ssDNA mediates non-enzymatic ligation of Oligo B to the 5′-terminus of ssDNA, under conditions in which no further ligation of Oligo A′ can occur. Libraries prepared by the method of the invention can be directly amplified by PCR or other methods. Amplified libraries, derived from minute quantities of RNA and DNA, can be used in gene expression studies, analysis of DNA polymorphisms, and high throughput sequencing. Methods of attaching the finished DNA Libraries to a solid supports for archiving are also disclosed. The invention further provides kits for carrying out the processes of the invention.

### CROSS-REFERENCE TO RELATED APPLICATIONS

This application claims priority to U.S. Provisional Patent Application Ser. No. 60/595,470.

### FIELD OF THE INVENTION

The present invention relates to an improved process and a kit for construction of a DNA library that is suitable for exponential or linear amplification processes.

### BACKGROUND OF THE INVENTION

A DNA library contains a representative set of DNA copies of the nucleic acid molecules present in an original sample, sandwiched between a nucleotide sequence at one end of all of the molecules and another sequence at the other end of all of the molecules. Conversion of an RNA or DNA population is often desired in order to characterize the nucleotide sequence composition of an RNA or DNA population. Creation of a DNA library is also desired to enable manipulation and analysis of a nucleic acid sequence population without having a priori knowledge of the sequences of the individual nucleic acid molecules.

Desirable characteristics of a useful DNA library include universal sequences at the termini of the DNA population that facilitate uniform exponential amplification and/or linear amplification of the population. Additionally, universal sequences may provide one or more other important functions such as facilitating the production of single-stranded DNA or RNA copies of the population, providing for easy ligation into plasmid and viral vectors, facilitating sequence normalization procedures, and facilitating attachment of the population to a solid support. More recently, it has become desirable that the universal sequences are capable of supporting in vitro clonal amplification (ICA) of the DNA library.

A classical approach to library genomic DNA and cDNA library construction is by ligating into plasmid and bacteriophage vectors. Amplifications of the libraries are then performed via growth in E. Coli following transformation (Cameron et al., (1977) Nucleic Acids Res. 4,1429-1448; Durnham et al., (1980) PNAS 77, 6511-1 5) Separate protocols have been designed for preparation of genomic DNA and cDNA libraries (Sambrook et al., (1989) Molecular Cloning a Laboratory Manual, 2^{nd} Ed. Cold Spring Harbor Laboratory Press, New York, Okayama and Berg, (1982) Mol. Cell Biol. 2,1 61-70). While these processes provide for uniform amplification of the nucleic acid population in E. Coli, the initial ligations required tens of nanograms to microgram quantities of RNA and DNA, making them less useful for small samples. Moreover, processes for constructing libraries from RNA such as disclosed in U.S. Pat. No. 4,985,359, rely on polyA sequence in the mRNA, limiting utility for RNAs which lack polyA.

Linker-mediated PCR involves the ligation of universal double-stranded oligos to cleaved double stranded DNA, followed by amplification using a single primer recognizing the linker sequence (Saunders et al., (1989) Nucleic Acids Res. 17, 9027-9037; Ko et al., (1990) Nucleic Acids Res. 1 4, 4293-4294). This method has been shown to result in very little bias in amplification across a complex genome, if combined with random fragmentation of the genomic DNA sample (Barker et al., (2004) Genome Research 14, 901-907). However, ligation of a single linker to double stranded DNA, limits the utility of the method. The method is not useful for situations in which the strandedness of the nucleic acid population must be preserved, such as for the construction of a library from single-stranded DNA viruses or from RNA. Moreover, the library prepared by this method is not suitable for applications requiring two different universal oligonucleotides such as in vitro clonal amplification (ICA). For example, processes have been disclosed for PCR-based ICA of DNA on solid supports (Dressman et al., (2003) Proc. Natl. Acad. Sci. USA 100, 8817-8822, Mitra et al., (1999) Nucleic Acids Res. 27, e34). These methods offer the potential to perform shot-gun sequencing of entire libraries using a sequencing-by-synthesis (SBS) approach while avoiding time-consuming and labor intensive cloning of individual sequence in microorganisms (WO 2004/069849 A2). However, because the SBS reactions must proceed in one direction along the template DNA, the sequencing primer has to anneal at only one end of each molecule. Thus two unique oligonucleotide sequences must be used for the ICA reactions.

In vitro transcription is also a convenient method to generate a labeled population of RNA that is representative of the library, and therefore the original DNA population. All though it might be possible to perform in vitro transcription with a library containing the RNA promoter sequence at both ends, it is not preferred, and therefore a disavantage of libraries generated by linker-mediated PCR.

U.S. Patent Application No. 200401 85484 to Costa discloses a process for construction of a DNA library containing a first universal oligonucleotide on one end of each DNA molecule and a second different universal oligonucleotide on the other end of each DNA molecule (U.S. Patent Application 200401 85484). In the method, randomly fragmented double-stranded DNA is polished and ligated in a single reaction to two different double-stranded linkers (A and B). Such a ligation results in at least three products: molecules with two A linkers, molecules with two B linkers, and molecules with an A linker on one end and a B linker on the other end. Costa also disclose a protocol for isolation of single-stranded molecules of the desired structure from this mixture.

The method of Costa and colleagues suffers from several limitations. First, there is a requirement for a special purification protocol in order to isolate molecules containing the A adapter on one end and the B adapter on the other end. Second, the method is not useful for situations in which information about the strand polarity of the original nucleic acid molecules must be preserved, such as for the construction of a library from single-stranded DNA viruses or from RNA. Moreover, the method is not particularly well suited to the preparation of a library from RNA because the disclosed process requires a double-stranded DNA library population for the ligation. In addition, second strand synthesis of DNA is expensive and time consuming.

Various methods have been disclosed for library construction from RNA. Under classical approaches, construction of cDNA libraries using plasmid and phage-based vectors followed by subsequent cloning in E. Coli, facilitate the isolation and sequencing of individual CDNA species, and subsequent analysis of the corresponding mRNAs by such techniques as Northern blot, RNase protection, and dot-blot hybridization. However, as mentioned above, the plasmid and phage-based methods of library construction are not useful for the analysis of small cell populations such a highly differentiated brain regions or tumor biopsies (Van Gelder et al., (1990) Proc. Natl. Acad. Sci. USA 87, 1663-67).

Several methods have been described for the construction of PCR amplifiable DNA libraries from RNA. In 1989, two separate groups disclosed similar methods consisting of (1) priming reverse transcription with oligo dT, and then (2) tailing 1^{st} strand cDNA on the 3′ end with DGTP and terminal transferase (Belyavsky et al., (1989) Nucleic Acids Res. 17, 2919-2932; Tam et al., (I 989) Nucleic Acids Res. 17, 1269). In this way, a poly dT sequence was always found at one end of each molecule and a poly dG sequence was always found at the other end of each molecule. The single-stranded cDNA could then be amplified with two different primers, one containing a 5′-restriction endonuclease site and a 3′-poly-dT sequence, and another containing a 5′-restriction endonuclease site and a 3′-poly-dC sequence. This process was simplified by Brady and co-workers who primed reverse transcription with oligo dT and then added a poly dA tail to the first strand cDNA using dATP and terminal transferase (Brady et al., (1989) Meth. Mol. Cell. Biol. 21, 17-25). PCR amplification of the cDNA could then be achieved with a single universal primer with a 5′ unique sequence and a 3′-poly-dT sequence. Additional methods were recently proposed in which reverse transcription was primed with an adapter with a 5′-universal sequence and a 3′ oligo dT, and a second universal sequence was ligated to the 3′-end of the single-stranded cDNA by a number of techniques (U.S. Pat. No. 6,706,476; U.S. Patent Application 20030104432)

While these methods prove useful for extremely small amounts of RNA and, most maintain the information about the sequence polarity of the original RNA, all of these disclosed methods have the distinctive disadvantage that attachment of a universal sequence to one end of the cDNA is based on reverse transcription primed by oligo dT. Since the oligo dT primer anneals to the polyA sequences of mRNA which are mainly located near the 3′- terminus of mRNA, the amplified libraries generated by such methods generally under-represent sequences from the 5′-end of mRNAs. Additionally, the methods are also not useful for constructing libraries from DNA samples, or RNA populations that don't contain the polyA sequence.

The template switching method for generating adapted cDNA molecules was designed to improve representation of the 5′-end of mRNA molecules in the cDNA (Chenchik, et al., (1998) In Siebert, P., and Larrick, J. (eds), Gene Cloning and Analysis by RT-PCR, Biotechnique Books, Natick, Mass., pp. 305-319). The method takes advantage of a property of MMLV reverse transcriptase (RT); that is, when the RT gets to the 5′-end of the mRNA template it adds a few non-encoded C residues to the 3′-end of the 1^{st} strand cDNA. In this method an oligo-dT primer with a 5′-universal sequence is used to prime reverse transcription in a reaction containing a lower amount of a “template-switching” oligonucleotide that consists of a universal sequence with 3 G residues on the 3′-end. After the RT gets to the 5′-end of the mRNA template, it adds the non-encoded Cs. The RT is then able to switch strands and prime synthesis off the 3′-OH of the template-switching oligo which base-pairs with the non-encoded C homopolymer. The universal tag introduced with the oligo dT primer and the template switching primer can then be used as priming sites for amplification of the full-length cDNAs.

While the template switching method is useful for the cloning of full-length RNAs, it is not useful as a general library construction technique. First, it does not work with DNA or RNA that lacks the poly A sequence. Second, because the method relies on specific priming at the distal ends of the mRNA/cDNA molecules, the average size of the DNA molecules comprising the library will be larger than optimal. Smaller DNA molecules of the library, derived from shorter mRNAs in the initial population will amplify more efficiently than larger molecules. Uneven amplification is detrimental for such downstream applications as microarray analysis of gene expression. Uniform amplification of all sequences is generally preferred, so that the relative prevalence of a specific cDNA type in an amplified library will be the same as for the corresponding mRNA in the starting population.

To facilitate good 5′-coverage of cDNA, while eliminating the bias caused by inefficient amplification of long cDNA, several groups have demonstrated the use of tagged-random primers rather than oligo dT primers for first strand synthesis. The approach was first described by Silver and Feinstone in 1989 (U.S. Pat. No. 5,104,792). Klein and co-workers developed a protocol in which reverse transcription is primed by a special primer of the structure 5′-C15-X-N8-3′, in which C represents Cytosine, X represents a 7 nucleotide universal sequence and N represents a random mixture of the 4 deoxynucleotides at each position. After first strand synthesis the cDNA was tailed with dGTP and terminal transferase. This facilitated PCR amplification using a single universal primer with 15 Cytosines at the 3′-end (Klein et al., (2002) Nature Biotech. 20, 387-392). Castle and co-workers primed reverse transcription with a primer of structure 5′-X-N9, where X represents a 1 2 nucleotide universal sequence and N was as described above. Second strand cDNA synthesis was primed with a primer of structure 5′-Y-N9 where Y represents another 1 2 nucleotide universal sequence. In this way 1 2 nucleotide universal tags were incorporated in each end of the cDNA, and these served as priming sites for PCR amplification with primers whose 3′-ends matched the X and Y universal sequences (Castle et al., (2003) Genome Biol. 4, R66).

The methods of Klein and coworkers and of Castle and coworkers improve representation of sequences derived from the 5′-ends of mRNAs in the libraries, will work with non-polyadenylated mRNAs, and could also be adopted to work with DNA samples. Additionally, the method of Castle and coworkers provides one universal sequence at one end of each DNA molecule, and another different universal sequence at the other end of each DNA molecule in the library. However, these methods still have the disadvantage that they use oligonucleotides with specific tag sequences at their 5′-end for priming reverse transcription and second strand synthesis. Priming with specific sequences, may lead to over representation of some sequences and under-representation of other sequences in the resulting DNA libraries. For example, since the universal tag sequences may preferentially bind to certain RNA sequences during reverse transcription, priming sites may not be entirely random.

In summary, all of the disclosed methods above have limitations in constructing a DNA library. Almost all of the methods are designed to work only with DNA or RNA but not both. Many of the methods for RNA rely on priming with nucleotide primers that have specific sequences, which can lead to bias, or do not work if the target sequence is absent. Methods for library construction starting from DNA also typically use the same universal sequence on both ends of the library molecules, limiting utility for in vitro transcription and/or in vitro clonal amplification of the library. There is a need for a method of library construction with all of the following advantages: 1. Utilization of a random primer for reverse transcription or priming on the DNA template which is preferable for uniform representation in the library. 2. Provides a single enzymatic step process to prepare DNA molecules for ligation starting from single or double-stranded RNA or DNA. 3. Provides a first universal sequence at one end of each molecule, and a second different universal sequence at the other end of each molecule in the library. In addition, the present invention provides a rapid method for attaching the finished library to a solid support for archiving. All of these advantages are achieved in the present invention due to the discovery of the utility of 5′-end or 3′-end chemical modifications for use with single-stranded DNA ligations.

### SUMMARY OF THE INVENTION

The present invention comprises processes for the construction of a DNA library by ligation of universal sequences to the termini of a population of single-stranded DNA (ssDNA) molecules. In one aspect of the invention, single-stranded DNA containing a chemical modification (CM) at or near the 5′ or 3′-terminus is prepared from an RNA or DNA sample. A first universal oligonucleotide (Oligo A′) is ligated to the 3′-terminus of the ssDNA. A second universal oligonucleotide (Oligo B) is ligated to the 5′-terminus of the ssDNA. The order of the ligations depends on the specific embodiment. In some embodiments, Oligo A′ is ligated to the 3′-terminus of the ssDNA prior to ligation of Oligo B to the 5'terminus. In some embodiments the order of ligation is reversed. In some embodiments the ligation reactions occur simultaneously.

Regardless of the sequence of the ligation reactions, a chemical modification (CM) at or near the 5′- or 3′-terminus of the ssDNA is required in the processes used to block ligation of Oligo A′ and Oligo B to each other. A CM useful for the invention can be any attached chemical group, or any chemical alteration of the DNA structure located at or near the 5′- or 3′-terminus of the ssDNA, provided that said chemical group or alteration can be used to directly or indirectly to block ligation of Oligo A′ to Oligo B. In some embodiments the CM is attached to the 5′-terminal carbon of the DNA strand. In other embodiments the CM is located within 1-10 nucleotides from the ssDNA 5′-terminus. In one aspect of the invention, the CM is a chemical group that can mediate binding of the ssDNA to a solid support and can be easily removed to restore a free 5′-phosphate. In another aspect of the invention, the CM is a chemical group that can mediate a DNA ligation reaction proceeding by a non-enzymatic mechanism. In one embodiment of the invention the CM is a 5′-photocleavable biotin (PC-biotin) or a 5′-lodo group.

The first step according to one embodiment of the present invention is the preparation, from an RNA or DNA sample, of ssDNA with a CM at or near the 5′ or 3′-terminus. The CM may be introduced at or near the 5′-terminus of the ssDNA by any number of methods known in the art including reverse transcription or DNA synthesis using an oligonucleotide primer containing the CM. In one aspect of the invention, the CM is introduced during reverse transcription of RNA with a random primer containing a CM at the 5′-terminus. In another aspect, the CM is introduced by DNA synthesis on a denatured double-stranded DNA template using a random primer containing a CM at the 5′-terminus. The CM may also be introduced by inclusion at the 5′-terminus of a random primer used to prime DNA synthesis on an ssDNA template. The CM may also be attached at or near the 5′-terminus of ssDNA by direct enzymatic or chemical coupling. In some embodiments of the invention, the CM is introduced at or near the 3′-terminus of the ssDNA by 3′-addition of chemically modified nucleotides using a DNA polymerase or terminal transferase enzyme.

In one embodiment of the invention, ssDNA with a 5′-terminal CM is 1^{st} bound to a solid support via a high affinity interaction between the solid support and the CM (FIG. 1). In this embodiment, PC-biotin is a preferred CM. Oligo A′ is ligated to the 3′-terminus of the solid support-bound ssDNA, then unreacted Oligo A′ is washed away. The solid support bound ssDNA may also be treated with a phosphatase to inactivate any residual unreacted Oligo A′. The CM is then removed by a process that does not damage the ssDNA, restoring a 5′-phosphate on the ssDNA, and releasing the ssDNA from the solid support. In some embodiments using a PC-biotin CM, the CM is removed by exposure to UV-B light. Oligo B is then ligated to the 5′-terminus of the ssDNA, resulting in an ssDNA library. In another embodiment described in FIG. 1, ligations of Oligo A′ and Oligo B are catalyzed by an RNA ligase or a DNA ligase with activity on ssDNA. Alternatively, a stabilizer oligonucleotide complementary to sequences at the junction of the specific universal oligonucleotide and the ssDNA may be added prior to or during ligation reactions. Use of a stabilizer oligonucleotide will allow catalysis of Oligo A′ or Oligo B ligation to ssDNA by standard double-stranded DNA-dependent ligases.

In another embodiment, a CM at the 5′-terminus of ssDNA mediates ligation to Oligo B by a non-enzymatic mechanism (FIG. 2). In this embodiment the CM may be a 5′-terminal iodo group and Oligo B may contain a 3′-phosphorothioate moiety. However, other pairs of chemical moieties capable of mediating non-enzymatic ligation may be attached at the 5′-terminus of the ssDNA and at the 3′-terminus of Oligo B. The ssDNA 3′-terminus is first ligated to the 5′-terminus of Oligo A′. In an embodiment described in FIG. 2, ligation to Oligo A′ is catalyzed by an RNA ligase or a DNA ligase with activity on ssDNA. In other embodiments, ligation of the ssDNA 3′-terminus to Oligo A′ is catalyzed by a standard DNA ligase with activity on double stranded DNA (in presence of stabilizer oligonucleotide). The 5′-terminus of the ssDNA is then joined to the 3′-terminus of Oligo B by a non-enzymatic ligation, under conditions in which no further ligation of Oligo A′ can occur (FIG. 2). In some embodiments, the non-enzymatic ligation occurs by a chemical reaction between a 3′-phosphorothioate on Oligo B and a 5′-iodo group on the ssDNA. The non-enzymatic ligation usually requires a stabilizer oligonucleotide that is complementary to both the 3′-end of Oligo B and the 5′-end of the ssDNA. The portion that is complementary to the ssDNA 5′-end can consist of a series of 1-10 random nucleotides (FIG. 2).

In one aspect of the invention, a double-stranded DNA library is prepared from the ssDNA library using two additional steps (FIG. 3) In the first step, the library is hybridized to Oligo A, which is complementary to Oligo A′. In the second step, Oligo A is extended by a DNA polymerase, thereby creating a double stranded version of the library (FIG. 3). In some embodiments, Oligo A is attached by covalent or hydrogen bonding to a solid support, and hybridization of the ssDNA library to Oligo A and DNA polymerase extension of Oligo A results in a double-stranded DNA library bound to a solid support (FIG. 4).

### BRIEF DESCRIPTION OF THE DRAWINGS

FIG. 1: Scheme for construction of a DNA library according to an embodiment of the current invention.

FIG. 2: Scheme for construction of a DNA library according to a second embodiment of the current invention whereby a chemical modification mediates non-enzymatic ligation.

FIG. 3: Scheme for construction of a soluble double-stranded DNA library according to a third embodiment of the current invention wherein the ssDNA library prepared in FIG. 1 or FIG. 2 is hybridized to Oligo A, and Oligo A is extended with DNA polymerase, to generate a double-stranded DNA library.

FIG. 4: Scheme for construction of a solid support-bound double-stranded DNA library according to a fourth embodiment of the current invention whereby the ssDNA library prepared in FIG. 1 or FIG. 2 is hybridized to solid-support-bound Oligo A, and Oligo A is extended with DNA polymerase, to generate a double-stranded DNA library.

FIG. 5: Process for complementary RNA preparation utilizing photocleavable-biotin according to one embodiment of the current invention. (A) Denaturation and random fragmentation of RNA. (B) Random-primed cDNA synthesis with PCB-N6 primer. (C) Ligation of linker A′ to 3′-end of ss-cDNA. (D) Binding of ss-cDNA to streptavidin-coated magnetic beads. (E) Washing of beads and release of 5′-phophorylated ss-cDNA by 360 nM irradiation. (F) Ligation of linker B-T7. (G) 12-20 cycles of PCR (H) In vitro transcription incorporating biotinylated NTPs. Note that ligation of Linker A′ and Linker B to the 3′ and 5′ end, respectively, of single-stranded cDNA is catalyzed by T4 DNA ligase using linker-complementary oligos containing terminal random hexamer sequences that create a transient double-stranded substrate for ligation. Times listed are total processing and incubation time for 2 samples. Dotted line brackets four steps that can be replaced by a single combined non-enzymatic/enzymatic ligation.

FIG. 6: Fragmentation of synthetic HCV RNA according to one embodiment of the current invention. (A-C) An 8.5 kb 3′-truncated HCV synthetic transcript (400 ng) was incubated in the presence of Ca++ (A), Mg++ (B), or Zn++ (C) ions at indicated concentrations for 3 minutes at 830 C, and then purified on Sephadex G50 and electrophoresed on 1.8% agarose-2% formaldehyde gels. Fragmentation with 20 mM Mg++ produced RNA fragments averaging 700 nucleotides in length. Incubation with Zn++ at one hundred-fold lower concentrations (0.2 mM) yielded similar levels of fragmentation.

FIG. 7: PCR Amplification of cDNA libraries prepared from synthetic HCV RNA according to an embodiment of the present invention. (A) 15, 5, 1, or 0 nanograms of HCV RNA-derived PC-biotin-cDNA was adapted with linkers and amplified in 30 cycles of PCR. Libraries were purified on either Sephacryl S300 (lanes 1-4) or Sephacryl S400 (lanes 5-8) mini-spin columns prior to PCR. (B) 50, 20, 5, or 0 nanograms aliquots of 8.5 KB synthetic HCV RNA were fragmented by incubation at 86 C for 5 minutes in 3 mM Magnesium Acetate, converted to random-primed 5′-PCB-cDNA, adapted with linkers, and amplified in 30 cycles of PCR. The 5′-PCB cDNA was either purified by Qiagen MinElute kit (lanes 1-4) or by sequential Sephacryl S300 mini-spin and MinElute columns (lanes 5-8) prior to linker adaptation.

FIG. 8: Preparation of amplified cRNA from various template RNAs according to an embodiment of the current invention. Electrophoresis of cRNA on a 2% agarose-formaldehyde gel is shown. Synthetic 8.5 kb HCV RNA (lane 1-2) or ribosomal RNA-depleted mouse N2A cell line RNA (lanes 3-6) was reverse transcribed with a 5′-PC-biotin-labeled random primer. The PC-biotin-labeled cDNA was adapted with linkers, PCR-amplified, and transcribed in to cRNA by the standard process described in FIG. 5. For lanes 5-6, cDNA was spun through a Sephacryl S400 mini-column prior to minElute column purification.

### DETAILED DESCRIPTION OF THE INVENTION

The present invention relies on many patents, applications and other references for details known to those of the art. Therefore, when a patent, patent application, or other publication is referenced in this disclosure, it should be understood that it is incorporated by reference in its entirety for all purposes as well as for the proposition that is recited.

### DEFINITIONS

As used in this disclosure, the singular form “a,” “an,” and “the” include plural references unless the context clearly dictates otherwise. For example, the term “universal oligonucleotide A” includes a plurality of oligonucleotides all of which have the same sequence and chemical modifications.

Throughout this disclosure specific forms of nucleic acids are referred to using standard abbreviations. For example, “RNA” means ribonucleic acid, “DNA” means deoxyribonucleic acid, “ssDNA” means single-stranded DNA, and “dsDNA” means “double-stranded DNA”.

It should be understood that within this disclosure, nucleic acids described in the singular form, such as ssDNA, RNA, and DNA are intended to mean a population of nucleic acid molecules, except where the context clearly dictates otherwise. For example, “ssDNA” means a population of ssDNA molecules. The exception to the above rule is the singular form of “oligonucleotide”, which means a plurality of oligonucleotides of the same molecular composition, unless the context clearly dictates otherwise. As used in this disclosure, a population of a specific type of nucleic acid molecule (e.g. a population of ssDNA molecules) means a plurality of said molecules comprising many different individual molecules differing from each other in their nucleotide sequences. In specific embodiments of this invention a population may contain greater than 10, greater than 100, greater than 1000, or greater than 10,000 different nucleic acid molecules.

As used in this disclosure, a “DNA library” is a population of DNA molecules in which a first universal sequence is located at the first end of all of the molecules making up a population of DNA molecules, and a second universal sequence is located at the second end of all of said molecules making up said population of DNA molecules. The universal sequences can be derived from oligonucleotides, RNA, DNA, plasmid vector sequences, and the like.

As used in this disclosure, the 5′-end of an oligonucleotide, ssDNA, or RNA means at or near the 5′-terminus of the oligonucleotide, ssDNA, or RNA. As used in this disclosure, the 3′-end of an oligonucleotide, ssDNA, or RNA means at or near the 3′-terminus of the oligonucleotide, ssDNA, or RNA. Generally, near the 5′-terminus or 3′-terminus means within 40 nucleotides of the 5′-terminus or the 3′-terminus, respectively. A sequence at the 5′-end of an ssDNA comprises the nucleotide sequence starting at the 5′-terminus of the ssDNA and extending for up to 40 nucleotides. A sequence at the 3′-end of an ssDNA comprises the nucleotide sequence starting up to 40 nucleotides from the 3′-terminus and extending to the 3′-terminus.

As used in the disclosure, a CM means a chemical modification. Photocleavable biotin, a 5′-iodo group and a 5′-tosyl group are examples of CMs used in certain embodiments of the invention. A “5′-CM” or a “3′-CM” means a chemical group attached at or near the 5′- or 3′-terminus of a nucleic acid molecule, or a chemical alteration of a nucleic acid molecule at or near the 5′- or 3′-terminus of said molecule, or a chemical group that is brought in to proximity (e.g. 5 nanometers) of the 5′- or 3′-terminus of a nucleic acid molecule through direct or indirect molecular interactions with said molecule, respectively. Likewise, a “CM at or near the 5′-terminus” or a “CM at or near the 3′-terminus” means a chemical group attached at or near the 5′- or 3′-terminus of a nucleic acid molecule, or a chemical alteration of a nucleic acid molecule at or near the 5′ or 3′-terminus of said molecule, or a chemical group that is brought in to proximity (e.g. 5 nanometers) of the 5′- or 3′-terminus of a nucleic acid molecule through direct or indirect molecular interactions with said molecule, respectively. When referring to CMs at or near an ssDNA terminus, “near the 5′- or 3′-terminus” preferably means much closer than 40 nucleotides from the 5′- or 3′-terminus. For example, a 5′-CM is preferably located within 20 nucleotides, more preferably within 10 nucleotides, and most preferably within 5 nucleotides of the 5′-terminus. A 5′-terminal CM means a CM attached to the 5′-terminus of the nucleic acid being described, and a 3′-terminal CM means a CM attached to the 3′-terminus of the nucleic acid being described. Also in this disclosure “5′-chemically modified ssDNA” or “3′-chemically modified ssDNA means an ssDNA with a CM at or near the 5′- or 3′-terminus, respectively.

As used in this disclosure, a degenerate sequence is: a mixture of nucleotide sequences in which each nucleotide position contains a random nucleotide, or a single nucleotide sequence in which each nucleotide position contains a specific nucleotide with similar binding affinity for all 4 of the standard bases found in DNA (Adenine, Cytosine, Guanine, Thymine) or RNA (Adenine, Cytosine, Guanine, Uracil), or a mixture of nucleotide sequences containing both random nucleotides and specific nucleotides with similar binding affinity for all 4 standard bases. Each nucleotide position in a sequence mixture that contains a random nucleotide contains approximately 25% each of dAMP, dCMP, dGTP, and dTTP. A random primer contains a random nucleotide at every position. An example of a specific nucleotide with equal binding affinity for all 4 standard nucleotides is deoxyinosine monophosphate. An oligonucleotide containing a degenerate sequence can bind most target nucleic acid molecules in a population with similar affinity.

Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques of organic chemistry, polymer technology, molecular biology (including recombinant techniques), cell biology, biochemistry, and immunology, which are within the skill of the art. Such conventional techniques include isolation of RNA and DNA from biological samples, fragmentation of RNA and DNA, hybridization, ligation, reverse transcription, DNA synthesis, oligonucleotide synthesis, size-fractionation, and others. Specific illustrations of suitable techniques can be had by reference to the example herein below. However, other equivalent conventional procedures can, of course, also be used. Such conventional techniques can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), all of which are herein incorporated in their entirety by reference for all purposes.

Overview

The present invention comprises processes for construction of DNA libraries from both RNA and DNA samples. According to the method of the invention, single stranded DNA containing a chemical modification (CM) at or near the 5′ or 3′-terminus is first prepared from RNA or DNA. Next, a 1^{st} universal oligonucleotide (Oligo A′) is ligated to the 3′-terminus of the ssDNA, and a 2^{nd} universal oligonucleotide (Oligo B) is ligated to the 5′-terminus of the ssDNA. The order of the ligations depends on the specific embodiment. In some embodiments, Oligo A′ is ligated to the 3′-terminus of the ssDNA prior to ligation of Oligo B to the 5'terminus. In other embodiments the order of ligation is reversed. In other embodiments the ligation reactions occur simultaneously.

The CM is used to prevent the ligation of Oligo A′ and Oligo B to each other, either directly or indirectly. In one embodiment, a 5′-terminal CM mediates binding of the ssDNA to a solid support, enabling any unligated Oligo A′ to be washed away prior to removal of the CM and ligation of Oligo B to the 5′-terminus of the ssDNA. In a second preferred embodiment, a 5′-terminal CM mediates a non-enzymatic ligation of Oligo B to the 5′-terminus of the ssDNA. In the second embodiment, Oligo B contains a 3′-terminal modification (e.g. a phosphorothioate) enabling specific reaction with the 5′-terminal CM on the ssDNA but not with the 5′-terminus of Oligo A′ ; thus, Oligo A′ ligation to the 3′-terminus of the ssDNA and Oligo B ligation to the 5′-terminus proceed by mutually exclusive chemical mechanisms. Additional embodiments in which a 5′-CM on the ssDNA can enable ligation of Oligo A′ and Oligo B to the ssDNA while blocking ligation of Oligo A′ and Oligo B to each other can be conceived by one with skill in the art and are within the scope of the present invention.

In still other embodiments of the invention the CM is attached at or near the 3′-terminus of the ssDNA. In some embodiments, a CM is attached at or near the 3′-terminus of the ssDNA by 3′-terminal addition of a chemically modified nucleotide(s) (e.g. nucleotide with an attached photo-cleavable biotin), Oligo B is 1^{st} ligated to the 5′-terminus of the ssDNA, then the CM mediates binding of the ssDNA to a solid support while unligated Oligo B is washed away. Following removal of the CM, Oligo A′ is ligated to the 3′-terminus of the ssDNA in the absence of residual Oligo B. A terminal transferase or DNA polymerase enzyme is useful for terminal addition of chemically-modified nucleotides to the 3′-terminus of a DNA strand.

In other embodiments, a CM is attached at or near the 3′-terminus of the ssDNA by 3′-terminal addition of a chemically modified nucleotide(s) (e.g. a 3′-phosphorothioate containing nucleotide), then Oligo B is ligated to the 5′-terminus of the ssDNA by an enzymatic mechanism and Oligo A′ is ligated to the 3′-terminus of the ssDNA by a non-enzymatic mechanism mediated by the CM.

Prior to the present invention, there was no adequate process for constructing libraries via ligation of oligonucleotides to ssDNA, because there was no adequate method to prevent direct ligation of a 1 st universal oligonucleotide (Oligo A′) to a 2^{nd} universal oligonucleotide (Oligo B). An A′-B oligonucleotide dimer is formed by direct ligation of Oligo A′ to Oligo B. If the number of A′-B dimer molecules relative to the number of A′-ssDNA-B molecules in the library preparation is significant (e.g. >10%, >1%, or >0.1%), then downstream uses for the library are negatively impacted. For example, due to it's small size, amplification of A′-B dimer molecules will be greatly favored over amplification of A′-ssDNA-B molecules in such exponential amplification techniques as PCR, transcription-mediated amplification (TMA), nucleic-acid based sequence amplification (NASBA), and strand displacement amplification (SDA). The present invention solves the problem of A′-B dimer formation, through the unexpected discovery that CMs at or near the 5′-terminus of the ssDNA can be used in various embodiments to block direct ligation of Oligo A′ and Oligo B.

Because the present invention enables construction of nucleic acid libraries directly by ligation of universal oligonucleotides to both the 5′ and 3'termini of ssDNA, it provides one or more advantages over prior methods for library construction. Since ssDNA can be prepared from both single-stranded and double-stranded RNA or DNA samples in a single enzymatic step, the library construction processes of the invention is directly useful for all forms of nucleic acids. Some widely used prior methods for library construction used ligation of double-stranded oligonucleotide adapters to double-stranded DNA samples (see e.g. U.S. Patent Application 20040185484, Barker et al., (2004) Genome Research 14, 901-907, each of which are herein incorporated in their entirety by reference for all purposes), which is not preferred for construction of libraries from RNA or single-stranded DNA because: (1) a specific directional relationship between the universal sequences and the original strand of the RNA or ssDNA is not maintained, and (2) an extra enzymatic step is required to produce the 2^{nd} strand of the double-stranded DNA.

Another advantage of the present invention is the use of two different universal oligonucleotide sequences, one at each end of the ssDNA. Libraries prepared by the method of the invention (i.e. different oligonucleotides at the 5′ and 3′ ends of ssDNA) allow linking of a specific oligo sequence to the plus or minus strand of the original sample, and can be used in important applications such as in vitro clonal amplification (ICA) and subsequent sequencing by synthesis (SBS), that can only be performed on libraries with two different universal oligonucleotide sequences. Prior to this invention, library construction methods that provided for two different universal oligonucleotide sequences required, a specific priming event to form at least one end of the library (i.e. reverse transcription with oligo dT), special purification steps to isolate recombinate molecules with the proper structure (see U.S. Patent Application 20040185484 herein incorporated in it's entirety by reference for all purposes), or tagged random primers (see U.S. Pat. No. 5,104,792; Klein et al., (2002) Nature Biotech. 20, 387-392; Castle et al., (2003) Genome Biol. 4, R66; all incorporated herein in their entirety by reference for all purposes).

Use of tagged random primers may lead to over inclusion or under inclusion in the library of specific sequences from the source nucleic population. Thus, a significant advantage of the present invention is that it includes processes for production of DNA libraries from both RNA and DNA, wherein the ssDNA used for ligation is generated by random priming of reverse transcription or DNA synthesis on RNA or DNA samples, respectively. Random priming provides for uniform inclusion of the source nucleic acid in the constructed nucleic acid library, provided that the source nucleic acid does not have a biased overall sequence content. Due to the compatibility of the present invention with random priming it is useful for construction of libraries from unknown RNA and single-stranded DNA sequences such as from un-cloned viruses. Random priming is also compatible with a wide variety of methods for fragmentation of source RNA and DNA.

Construction of DNA Libraries by the method of the invention offers other advantages over prior methods. A chief advantage is that ssDNA can be prepared from either RNA or DNA samples in a single enzymatic step. However, a major hindrance to the widespread adoption of library construction by ssDNA ligation is the problem of direct ligation of the universal oligonucleotides to each other, which lead to contaminating dimers. The present invention resolves the problem by using a 5′-CM or a 3′-CM on the ssDNA in embodiments that prevent ligation of the universal oligonucleotides to each other.

The ssDNA libraries as well as the double-stranded DNA libraries produced by the method of the invention are directly suitable for amplification by PCR, transcription-based amplification, and other exponential amplification methods dependent on the presence of universal sequences at both termini of DNA molecules. Libraries prepared by the method of the present invention will not be contaminated with a substantial quantity of A′-B dimer molecules, the product of direct ligation of Oligo A′ and Oligo B. For example, the number of A′-B dimer molecules will be <10%, more preferably <1%, or most preferably <0.1% of the molecules in the DNA library preparation. Therefore amplification products will contain the universal sequences flanking a population representative of the original nucleic acid sample, and not a large amount of A′-B dimer molecules. A single round of exponential amplification by PCR and the like is capable of producing greater than 1×10⁶-fold increase in DNA mass as compared to the 100-1000-fold increase achieved using linear amplification such as IVT. Thus the library construction method of the present invention offers an advantage, for minute samples, over nucleic acid preparation methods that are only compatible with linear amplification techniques.

The present invention also offers significant advantages over prior art for construction of libraries from RNA and the analysis thereof. Prior art suffered from disadvantages such as the use of tagged random primers or poly-dT to prime reverse transcription. The present invention is compatible with priming of reverse transcription by completely random primers, which provides the most unbiased representation of the RNA sequence population in the DNA library that is produced.

Other prior art showed ligation of universal oligonucleotide adapters to double-stranded cDNA generated from RNA, thus a specific oligonucleotide sequence was not linked directly to the sequence containing the sense or antisense strand of the original RNA. In contrast, in libraries produced by the method of the invention the Oligo A′ and Oligo B oligonucleotide sequences are directly linked to the nucleotide sequences comprising the 3′- and 5′-ends, respectively, of the ssDNA. This relationship will be maintained after exponential amplification by PCR. If the original ssDNA is prepared by reverse transcription of RNA, and subsequently converted to a double-stranded DNA library by the method of the invention, then the DNA strand with the Oligo B sequence at the 5′-end in any and all of the DNA molecules of the library will contain the antisense sequence of the RNA. Likewise, the strand of the DNA containing the A sequence (complementary to Oligo A′) at the 5′-end will contain the original sense strand sequence of the RNA. This attribute is useful for applications involving analysis of gene expression. Regions of double-stranded DNA genomes are transcribed in to RNA. By sequencing individual molecules derived from the library construction process of the invention, it will be possible to know from which strand of the genome the particular RNA was derived.

A well known method in the art, for preparing a sample for hybridization to DNA microarrays, is to prepare a labeled population of RNAs containing the antisense sequences of the original RNA sample. Using the method of the invention, this can be achieved by including a bacteriophage promoter sequence as part of the sequence of Oligo B (see Van Gelder et al., (1990) Proc. Natl. Acad. Sci. USA 87, 1663-67, incorporated herein in it's entirety for all purposes). After preparation of a double stranded DNA library by the method of the invention, the library can be incubated with a bacteriophage RNA polymerase, and a mixture of labeled and un-labeled nucleotide triphosphates, as well as other necessary co-factors. If the library was prepared from an RNA source and the B sequence contained the bacteriophage promoter, then the incubation will produce a population of labeled antisense RNAs suitable for hybridization to a DNA microarray.

A significant advantage of the present invention is that it is useful for preparing libraries derived from DNA as well as RNA samples. In an embodiment of the invention ssDNA containing a 5′-terminal CM is prepared from a DNA sample by a DNA synthesis reaction primed by a random primer containing the CM. The ssDNA produced in the DNA synthesis step is then used to produce a DNA library by the method of the invention. The enzymes and reaction conditions used to make CM-modified ssDNA from DNA and RNA are different, but all of the remaining steps of library preparation are identical for both RNA and DNA sources. Important uses for libraries produced from DNA by the method of the invention are genomic sequencing and genome wide polymorphism analysis.

One skilled in the art of genomics will know how to use DNA libraries, prepared from a genomic DNA source by the method of the invention, to perform genomic sequencing or global polymorphism analysis. The method of the invention will be particularly useful when polymorphism analysis is required for biological samples containing limiting amounts of genomic DNA. The method of the invention streamlines the laboratory process, since the same oligonucleotides, enzymes, and other reagents, can be used for construction of libraries from both DNA and RNA sources.

Preparation of RNA and DNA Samples

There is no particular limitation to the types of samples that can be used as sources of DNA and RNA, for library construction according to the embodiments of the current invention. The processes of the invention are intended for use with nucleic acids derived from all types of organisms including viruses, viroids, prokaryotic organisms, protista, fungi, plants, protostomate animals, and deuterostomate animals including humans. For descriptions of the above organisms refer to Purves, W. K., Orians, G. H., and Heller, H. C. (1992) Life, the Science of Biology, pp 459-609.

Sources of nucleic acids may include tissue or fluid samples of fungi, plants, and animals, or the cultured cells thereof. The above tissue and fluid samples may contain nucleic acids from infectious, parasitic, symbiotic, or coincidently located viruses, viroids, prokaryotes, protista, and fungi. In some cases nucleic acids may be isolated from whole organisms such as coral, diatoms, sponges, deuterostomate embryos, and the like. Tissue samples may include fresh or frozen samples, frozen sections, formaldehyde-fixed sections, laser captured cells or tissue fragments, micro-dissected tissues, biopsies, micro-biopsies, needle aspirates, and others. Sources of human, animal, viral, and prokaryotic (bacterial) nucleic acids contemplated for use in the method of the invention are clinical fluid samples including blood, sera, saliva, semen, and the like. Samples of hair, scrapings of skin, and fingernail clippings, are also sources of nucleic acids contemplated for use in the method of the invention. Sources of nucleic acids may include specimens collected from the scene of an accident or crime scene including dried blood, dried semen, clothing samples, or any other sample containing DNA or RNA.

Nucleic acid sources may also include environmental samples containing prokaryotic and eukaryotic microorganisms, other small organisms, and viruses. These environmental samples, including soil, water, sludge, sediment, etc, may be taken from lakes, rivers, creeks, springs, or underground water. Nucleic acid sources may include samples of water obtained from drinking water supplies, sewage treatment plants, waste water, storm drains, run-off, and the like. Nucleic acid sources may also include samples of ocean water including samples taken near inlets, river mouths, storm drain outlets, hydrothermal vents, under water canyons, coral reefs, as well as sediment and rocks collected from the ocean floor. Nucleic acid sources may also include samples of ice, snow, and glaciers.

There is also no particular limitation to the methods used for isolation of RNA for library construction by the method of the invention, so long as the RNA produced is of adequate purity to allow subsequent steps. The particular protocol to be used will depend on the type of sample.

The RNeasy Kit, available from Qiagen Corp, Valencia, Calif. can be used to isolate RNA from most types of animal tissue and cultured animal cells. The acid guanidinium thiocyanate-phenol-chloroform RNA purification method, developed by Chomczynski and Sacchi as disclosed in 1987, Analy. Biochem. 162: 156-9, which is incorporated in its entirety by reference, can be used to prepare RNA from a wide variety of tissue samples and cultured cells). It is possible to isolate RNA from very small samples such as micro-dissected animal tissues, laser-captured cells from fixed or frozen sections, fluorescence activated cell-sorted cells, and fine needle aspirates, as by example, by using the RNeasy Micro Kit, available commercially from Qiagen, or the Nano-Scale RNA Purification Kit, available commercially from Epicentre Biotechnologies (Madison, Wis.). Zymo Research (Orange, Calif.) also manufactures and sells a range of kits for isolating RNA from very small samples containing as few as one cell.

Biological fluids such as blood, serum, saliva, urine, uterine fluid, etc, are important samples for clinical research and diagnostics that yield very small amounts of RNA. Qiagen Corp. offers a variety of kits for use in purifying RNA from clinical samples such as blood, serum, plasma, and other bodily fluids. A kit for isolating RNA from urine can be obtained from Zymo Research. A range of kits are also manufactured and sold by Epicentre Biotechnologies.

For preparation of RNA from samples of soil, sludge, sediment, and the like, special protocols are required, in order to remove contaminating clay minerals, and humic acids. A rapid protocol for the extraction of total nucleic acids from soil samples was developed by Griffiths and co-workers as disclosed in 2000, Appl. Enviro. Microbiol. 66: 5488-91, which is incorporated in its entirety by reference. After purification of total nucleic acids, it is possible to remove DNA by DNase I digestion, leaving intact RNA. A rapid protocol for extraction of RNA from freshwater sediment was developed by Miskin, Farrimond, and Head as disclosed in 1999, Microbiology, 145: 1977-87, which is herein incorporated by reference in its entirety. In order to purify RNA from water samples such as waste water, run-off, ocean water, canals, rivers, and the like it is necessary to first concentrate the microorganisms and/ or viruses by passing the water samples through filtration membranes. Once captured on the filter membranes, microorganisms and viruses can be eluted from the membranes and RNA can be extracted by RNeasy kit as disclosed in Griffin et al., 1999, Appl. Enviro. Microbiol. 65: 41 18-4125, which is incorporated by reference in its entirety. RNA may also be purified from the concentrated microorganisms and/or viruses by the acid guanidinium thiocyanate-phenol-chloroform purification method.

DNA templates may exist in nature as single or double-stranded forms, and may be linear or circular. All of these forms are suitable templates for construction of libraries by the method of the invention. There is no particular limitation to the method of preparation of DNA samples, for use in library construction by the present invention, so long as the method yields DNA that is sufficiently pure to allow the production of 5′- or 3′-chemically modified ssDNA. Methods of DNA isolation from a wide variety of biological samples are commonly known in the art. Methods for isolation of DNA from animal tissues, cultured cells, plant tissues, yeasts, and bacteria are described in common laboratory manuals such as Current Protocols in Molecular Biology (Ausubel et al., eds., John Wiley & Sons, 2004). Qiagen Corp (Valencia, Calif.) manufactures and sells a wide variety of DNA isolation kits, including kits for plasmid, viral, and genomic DNA isolation. Qiagen's kits can be used to isolate DNA from blood, other body fluids, small forensic samples such as blood spots, clinical samples such as buccal swabs and paraffin sections, animal tissues, cultured cells, bacteria, and plants.

Preparation of Chemically Modified ssDNAs

An appropriately sized population of ssDNAs containing a CM at or near the 5′- or 3′-terminus is obtained according to the present invention. Single-stranded or double-stranded forms of both RNA and DNA can be used to prepare the CM-containing ssDNA.

A single-stranded DNA sample (e.g. ssDNA extracted from an ssDNA virus) can be used directly for library construction, provided that there is means to attach a CM at or near the 5′- or 3′-terminus, and provided that the opposite end of the DNA contains an enzymatically ligatable terminus (e.g. 3′-hydroxyl or 5′-phosphate). In some embodiments of the invention, double stranded DNA samples are converted to ssDNA by chemical or thermal denaturation or enzymatic digestion; then a CM is attached to the 5′-terminus of the ssDNA by direct chemical modification, or a CM-containing nucleotide is added to the 3′-terminus of the ssDNA using terminal transferase or DNA polymerase. Alternatively a CM can be attached to either the 5′ or the 3′-terminus of both DNA strands in double-stranded DNA, and then ssDNA can be prepared using chemical, thermal, or enzymatic methods.

In some embodiments of the invention, a CM is included at the 5′-end of an oligonucleotide primer that is used to prime DNA synthesis on a single-stranded or denatured double-stranded DNA sample. DNA synthesis is conducted by mixing the denatured double-stranded DNA or single-stranded DNA sample with a DNA polymerase, deoxynucleotide triphosphates, buffers and co-factors, and an oligonucleotide primer, and incubating for a specified period of time and at a specified temperature.

There is no particular limitation to the sequence of the oligonucleotide primer used to prime DNA synthesis, so long as the primer is capable of annealing at some frequency (e.g., intervals of 600 nucleotides along the DNA template strand) to the DNAs of the population. In some embodiments of the invention, a multiplicity of oligonucleotide primers is used to prime DNA synthesis, each primer containing a known sequence designed to anneal to a specific target sequence. In other embodiments, the oligonucleotide primer comprises a set of related nucleotide sequences designed to anneal to genetically related DNA molecules. In some embodiments, the oligonucleotide primer used is a random primer with a 5′-terminal CM; thus, the CM can be incorporated at the 5′-terminus of the ssDNA produced, and knowledge of the template sequence is not required. In other embodiments the oligonucleotide primer comprises a degenerate sequence such as a poly-deoxyinosine sequence, or a sequence mixture in which some nucleotide positions contain random nucleotides and some contain deoxyinosine nucleotides. In yet other embodiments, the oligonucleotide primer comprises a 3′-degenerate sequence joined to a single 5′-terminal deoxythymidine that is attached at the 5′-carbon to a CM selected from the group comprising 5′-iodo, 5′-acetoamido, 5′-bromo, and 5′-tosyl.

After DNA synthesis, size exclusion chromatography or affinity binding to glass bead matrixes can be used to purify DNA away from unincorporated CMs, oligonucleotide primers, enzymes, nucleotides, and other small molecules. Affinity purification based on specific binding to the CM or CM-modified DNA may be required in order to purify 5′-chemically modified ssDNA away from template DNA. This affinity purification step is equivalent to the step of capturing the 5′-chemically modified ssDNA on a solid support.

In still other embodiments of the invention, DNA synthesis is used to create an ssDNA copy of a single-stranded or denatured double-stranded DNA sample, and then a 5′-CM is attached to the nascent ssDNA by direct enzymatic or chemical coupling.

If the sample to be used for construction of the DNA library is single-stranded or double-stranded RNA, then single-stranded DNA must be prepared by reverse transcription of the RNA sample. Reverse transcription is used to generate ssDNA from RNA samples or fragmented RNA. Conditions and methods for performing reverse transcription reactions are well known in the art (See e.g., Current Protocols in Molecular Biology, Ausubel et al., eds., 1994). Reverse transcription of RNA is conducted in aqueous buffer containing deoxynucleotide triphosphates, an oligonucleotide primer, and a reverse transcriptase. Any reverse transcriptase can be used, including RNaseH-negative, thermostable, or a standard reverse transcriptase from avian myeloblastoma virus or Moloney murine leukemia virus. In some embodiments of the invention, a CM is included at or near the 5′-terminus of the oligonucleotide primer that is used for reverse transcription; thus, the CM is incorporated at or near the 5′-terminus of the nascent ssDNA as the primer is extended by reverse transcriptase. In preferred embodiments of the invention a CM at the 5′-terminus of the oligonucleotide primer is incorporated at the 5′-terminus of the ssDNA during reverse transcription.

There is no particular limitation to the sequence of the oligonucleotide primer used to prime reverse transcription, so long as the primer is capable of annealing at some frequency (e.g., >25%) to the RNAs of the population. The oligonucleotide primer may contain an oligo dT sequence, consisting of a stretch of 10-20 T residues, which direct the primer to anneal to the polyA tails of mRNAs. The oligonucleotide primer may consist of a population of different primers, each consisting of a known sequence designed to anneal to a specific target sequence, or the oligonucleotide primer may have a degenerate sequence designed to anneal to genetically related RNA molecules. In most cases, and particularly when the sequence content of the RNA population is unknown, the preferred oligonucleotide primer will consist of a degenerate nucleotide sequence or a random nucleotide sequence.

Following reverse transcription, degradation of template RNA can be achieved by heating in the presence of NaOH, or by incubation with a cocktail of RNases. Purification of 5′-chemically modified ssDNA away from contaminates such as unincorporated oligonucleotide primers, free CMs, dNTPs, and enzymes may be accomplished by size exclusion chromatography, or affinity purification on a glass bead matrix.

Depending on the intended use for the library and the source of the original RNA or DNA sample the size distribution and average size of the chemically modified ssDNA may require adjustment prior to ligation to Oligo A′ and Oligo B. The size distribution of the library constructed by the method of the invention will be the same as the original ssDNA population except for the extra length added by Oligo A′ and Oligo B which are ligated on either end of each molecule. Any method known in the art can be used to obtain the appropriate size of ssDNA. For example, fragments of the desired size may be obtained by fractionation of the ssDNA population on an agarose gel, and purification of the ssDNA from an excised gel band. Methods of DNA and RNA fragmentation are well known in the art for their utility in adjusting the size distribution of DNA libraries. Single or double-stranded RNA or DNA samples used to prepare ssDNA with a 5′-CM or a 3′-CM may be fragmented in order to insure that said ssDNA will have an adequate size distribution and average size. Alternatively, ssDNA with a 5′-CM or a 3′-CM can be fragmented directly.

If the constructed DNA library will be used directly, without amplification, for production of microarray probes, cloning in microbial hosts, or sequencing, and the like, then the size distribution should be adequate for the particular use. For example, an appropriate size range of fragments for genomic shot-gun sequencing is 2,000-6,000 nucleotides. If after construction, the DNA library will be amplified by any of the methods known in the art, the size distribution of the library and therefore the ssDNA must be appropriate for the amplification method.

PCR is a commonly used exponential DNA amplification method, and it is well suited for use with libraries constructed by the method of this invention. In PCR, smaller DNA molecules may be amplified more efficiently than larger molecules, and DNA molecules above 2000 nucleotides in general show more variation in amplification efficiency. Therefore, if the library is intended for amplification by PCR, then ssDNA used to construct the library should be between 50 and 2000 nucleotides, more preferably between 100 and 1000 nucleotides, and most preferably between 200 and 700 nucleotides in length. Also the preferred coefficient of variation of the size distribution of the ssDNA should be less then 100%, more preferably less then 50%, and most preferably less then 30%.

Other exponential amplification techniques such as Nucleic Acid Sequence-Based Amplification (NASBA), Transcription-Mediated Amplification (TMA), and Strand Displacement Amplification (SDA) have their own requirements for optimal size distribution. Likewise, techniques for linear amplification of DNA such as In Vitro Transcription Amplification (IVT), Asymmetric PCR, and Single Primer Isothermal Amplification also have optimal size distributions for template DNA. In these cases, the ssDNA used to construct the library should have a size distribution, such that with the addition of the Oligo A′ and Oligo B fragments, the library will be of optimal size for the amplification method of choice.

In some embodiments of the invention, the average size and size distribution of 5′-chemically modified ssDNA molecules is controlled by fragmenting them directly. In one embodiment of the invention, 5′-chemically modified ssDNA of the appropriate size is fragmented by the following procedure: (1) Heat to 95 C for 5 minutes in 20 ul of 10 mM Tris-Cl, 0.1 mM EDTA. (2) Add 20 ul 0.5 M NaOH, 0.25 M EDTA, and heat to 65 C for 20 minutes. (3) Neutralize by adding 20 ul of 0.5 N HCl, 0.5 M Tris-Cl pH 7.5. (4) Pass ssDNA through Sephacryl S-300 spin columns.

In other embodiments of the present invention, an RNA sample is fragmented, and then single-stranded DNA is prepared by reverse transcription using a reverse transcriptase and an oligonucleotide primer. In some embodiments, the oligonucleotide primer used for reverse transcription contains a 5′-terminal CM, and in some embodiments the oligonucleotide primer used for reverse transcription has a random sequence. In these embodiments of the invention, the size of the resulting ssDNA is controlled by the fragmentation of the original RNA sample.

Provided that the fragmentation method does not mutate the RNA sequence, and acceptable RNA fragment size and size distribution is obtained, any method known in the art can be used for fragmentation of the RNA. RNA samples can be fragmented by a mechanical method such as sonication or nebulization, by enzymatic digestion, or by reaction with chemical reagents. Chemical reagents suitable for fragmentation include, but are not limited to, solutions of alkaline pH, solutions containing transition metals, or solutions of alkaline earth metals (see Huff et al., 1964, Biochemistry, 3: 501-506; Butzow and Eichorn, 1965, Biopolymers, 3: 96-107, all of which are incorporated herein in their entirety for all purposes). A particularly preferred method of RNA fragmentation is heating in the presence of calcium or magnesium ions. Buffers suitable for fragmentation of RNA contain calcium or magnesium ions at concentrations ranging from 1×10⁻⁴to 1 molar, from 1×10⁻³ to 3×10⁻¹ molar, and most preferably from 1{10⁻² to 1×10⁻¹ molar. In order to effect fragmentation, RNA should be incubated in the Ca++ or Mg++-containing buffers at temperatures ranging from 50° C. to 100° C., and most preferably at temperatures ranging from 70° C. to 90° C., for a period of 1-100 minutes, and most preferably for a period of 2-20 minutes.

In another embodiment of the invention, a DNA sample is first fragmented, then single-stranded DNA is prepared by DNA synthesis using a DNA polymerase and an oligonucleotide primer. In some embodiments, the oligonucleotide primer used for DNA synthesis has a random sequence, and in some embodiments the oligonucleotide primer contains a 5′-terminal CM. In these embodiments, the size of the resulting ssDNA is controlled by the fragmentation of the initial DNA sample.

There are several methods of random or semi-random fragmentation of DNA known in the art. However, unlike RNA, DNA is not cleaved at an appreciable level by transition or alkaline earth metals (Franklin, S. J. 2001, Curr. Opin. Chem. Biol. 5, 201-208). Complexes of lanthanide and cerium can cleave DNA but the high concentrations of reagents and DNA, and long incubation times required are not acceptable (Igawa et al., 1999, Nucleic Acid Symp Ser. 42, 231-32). Richards and Boyer, 1965, J. Mol. Biol. 11: 327-40, which is incorporated by reference, discloses fragmentation of DNA by sonication, acid, alkali, and enzymatic treatment. Random cleavage of DNA by DNase I digestion disclosed by Anderson, S. 1981, Nucleic Acids Res. 9, 3015-3027 or sonication as disclosed by Deininger, P. L., 1983, Anal. Biochem. 129, 216-223, all of which are herein incorporated by reference, can be used to prepare DNA prior to ligation in to bacteriophage cloning vectors. Fragmentation methods that rely on the generation of hydrodynamic shearing force produce DNA fragments that vary in size by less than 2-fold, and are therefore useful for production of “shot-gun” sequencing libraries in plasmid vectors (Oefner, P. J., 1996, Nucleic Acids Res. 24, 3879-3886, incorporated herein by reference in it's entirety). More recently, sonicated DNA fragments have been ligated to linkers and amplified by PCR prior to cloning in plasmid vectors as disclosed Ren et al., 2000, Science, 290, 2306-2309, also herein incorporated by reference.

Depurintation of DNA by incubation in 0.1-0.2 M HCl or heating in a low ionic strength solution was disclosed by Lindahl, T. and Nyberg, B., 1972, Biochemistry 11, 3610-18, and herein incorporated by reference. The resulting abasic sites can be excised enzymatically or by treatment with a number of reagents including sodium hydroxide as disclosed by Lindahl, T. and Andersson, A., 1972 Biochemistry 11, 3618-26, which is herein incorporated by reference. In a preferred method, depurination is achieved by heating to 90-100 C for 2-20 minutes in a low ionic strength buffer such as 10 mM Tris, 1 mM EDTA pH 8.0 as disclosed in U.S. Patent Application No. 2003143599, incorporated here in it's entirety for all purposes). The heat treatment itself causes cleavage of the template at some abasic sites. Remaining abasic sites function as termination sites for most polymerases. Thus, synthesis of 5′-chemically modified ssDNA on the depurinated sample DNA templates will give ssDNA fragments with average lengths equivalent to the average distance between abasic sites in the template.

Preparation of DNA Libraries from Chemically Modified ssDNA

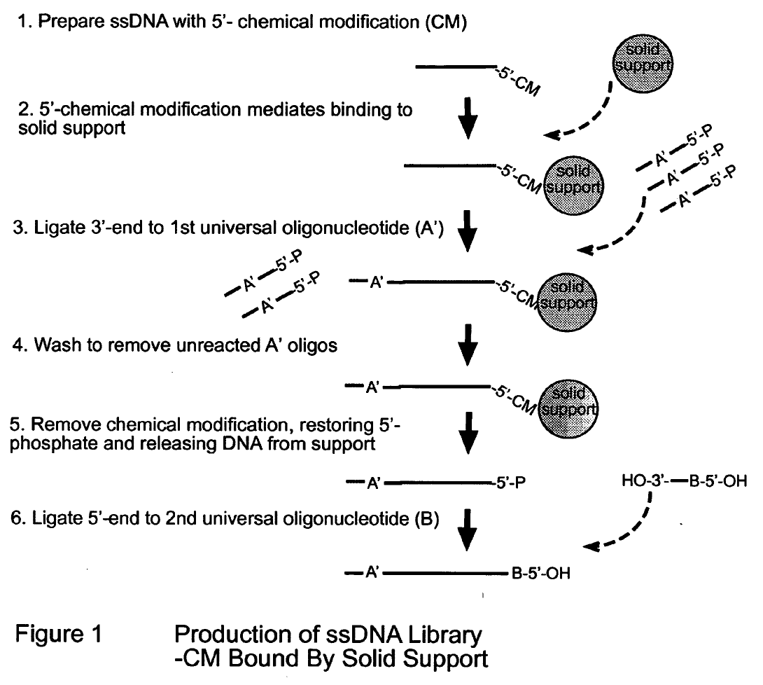

Referring now to the figures, FIG. 1 illustrates the construction of an ssDNA library according to one embodiment of the current invention. Step 1 comprises preparation of ssDNA with a 5′-terminal CM, and is described above for both RNA and DNA samples. Although there are various 5′-terminal CMs known in the art which can be used in the present invention, one preferred CM is a 5′-terminal CM that mediates binding to a solid support and which can be removed to restore a free 5′-phosphate on the ssDNA such as a photocleavable biotin (PC-biotin). Oligonucleotides with a 5′-terminal PC-biotin are available from Integrated DNA Technologies (Coralville, Iowa). PC-biotin phosphoramidites are commercially available from Glen Research (Sterling, Va.). PC-biotin binds with very high affinity to a streptavidin-coated surface, and can be removed by exposure to 365 nm UV light as disclosed by Olejnik, 1996, Nucleic Acids Res. 24, 361-366, the details of which are hereby incorporated by reference in their entirety. In addition to PC-biotin, any 5′-terminal CM that can bind tightly to a solid support, and can also be easily removed to generate a free 5′-phosphate is useful for the method of the invention.

Referring now again to FIG. 1, the 5′-terminal CM mediates binding of the ssDNA to a solid support (step 2). There is no particular limitation to the types of solid supports that can be used in this embodiment of the current invention, so long as the CM can bind with high affinity to the surface of the support. Solid supports may include microtiter plate wells, regular and magnetic beads, microfuge tubes walls, filtration membranes or matrixes, the walls of microfluidic channels or capillaries, reaction chambers, or nanoparticles, all of which are well known in the art. In preferred embodiments, the solid support is coated with streptavidin or avidin in order that it may bind the PC-biotin chemical modification.

Referring now again to FIG. 1 according to one embodiment of the current invention, in step 3, Oligo A′ is ligated to the 3′-terminus of the ssDNA. Oligo A′ must have a 5′-phosphate group, and it is preferred that the 3′-terminus of Oligo A′ is blocked with a phosphate, amino, dideoxy, or other chemical group. There is no particular limitation on the nucleotide sequence of Oligo A′, so long as Oligo A′ is not complementary to the ssDNA sequences or Oligo B. In some embodiments, Oligo A′ contains the antisense strand of a bacteriophage RNA polymerase promoter such as the promoter sequence for T3, SP6, or T7 bacteriophage. In other embodiments, Oligo A′ contains a recognition site for a restriction endonuclease.

In some embodiments Oligo A′ is ligated to the 3′-terminus of the ssDNA using an RNA ligase or a DNA ligase with activity on single-stranded DNA. T4 RNA ligase is available commercially from a number of companies such as New England Biolabs (Beverly, Mass.). A thermostable single-stranded DNA ligase is also readily commercially available such as from Prokaria (Reykjavik, Iceland).

In other embodiments, Oligo A′ is ligated to the 3′-terminus of the ssDNA by a double-stranded DNA (dsDNA)-dependent ligase, such as T4 DNA Ligase, E. Coli DNA Ligase, or Taq DNA Ligase. Ligation of Oligo A′ to the 3′-terminus of ssDNA with a dsDNA-dependent ligase requires an additional stabilizer oligonucleotide to create a transient double-stranded region at the juxtaposition of Oligo A′ and the 3′-end of the ssDNA. In preferred embodiments, the stabilizer oligonucleotide has 4-30 nucleotides of sequence complementary to Oligo A′ at the 5′-end, and from 1-10 random nucleotides at the 3′-end (see U.S. Patent Application 20030104432, incorporated herein it's entirety for all purposes). The stabilizer oligonucleotide generally has a hydroxyl group at the 5′-terminus and a blocked 3′-terminus to prevent spurious ligation of the stabilizer oligonucleotide to the other reactants. As an example, if Oligo A′ has the structure: P-5′-CCTTTAGTGAGGGTTAATTCC-3′-NH2 (SEQ ID No: 1). A typical stabilizer oligonucleotide structure is: HO-5′-GGAATTAACCCTCACTAAAGGNNNN-3′-NH2 (SEQ ID No: 2)

In some embodiments, after allowing the ligation reaction with Oligo A′ to proceed for a certain period of time, the ligation mixture is treated with a phosphatase enzyme. Treatment with the phosphatase removes the 5′-phosphate from Oligo A′, blocking any further ligation from occurring. Useful phosphatases include calf intestinal alkaline phosphatase, and arctic shrimp alkaline phosphatase, all of which are available commercially.

Referring now again to FIG. 1 according to one embodiment of the current invention, in step 4, unligated Oligo A′ is removed by thorough washing of the support and/or inactivation by phosphatase treatment. In the alternative, binding of the ssDNA to a solid support may also occur after ligation of Oligo A′, but before washing/inactivation of Oligo A′.

Physical removal of Oligo A′ is generally achieved by thorough washing of the solid support under buffer conditions which preserve the strong binding between the solid support and the 5′-chemically-modified ssDNA and which minimize non-specific binding of Oligo A′ to the support. The method of washing solid supports containing bound bio-molecules are well known in the art, and depend upon the physical nature of the solid support. If phosphatase was used in step 3 as outlined above in one preferred embodiment of the current invention, then the solid-support must also be washed under conditions that will remove the phosphatase.

In step 5 of the current embodiment illustrated in FIG. 1, the 5′-CM is removed, releasing the ssDNA from the support, and restoring a free 5′-phosphate on the ssDNA. The method of removal of the 5′-CM from the ssDNA will depend on the nature of the CM. Any physical, chemical, or enzymatic method that is capable of removing the CM without damaging the ssDNA molecules is acceptable. Removal of the CM, also restores the 5′-phosphate group on the ssDNA molecules, and detaches the ssDNA molecules from the solid support. Molecules of ssDNA containing a ligated Oligo A′ on their 3′-end and a 5′-phosphate, are recovered in aqueous solution.

Referring now again to FIG. 1 according to one embodiment of the current invention, Oligo B is next ligated to the 5′-terminus of the ssDNA (step 6). To prevent self-ligation, Oligo B must not have a 5′-phosphate group. A 3′-hydroxyl on Oligo B is necessary for ligation to the ssDNA to occur. The sequence of Oligo B should be a universal sequence that is not complementary or similar to sequences within Oligo A′ or the ssDNA. In some embodiments, Oligo B will contain a promoter sequence recognized by an RNA polymerase such as a T7, T3, or SP6 bacteriophage polymerase. In some embodiments Oligo B will contain restriction endonuclease recognition sites (e.g., recognition sites for BamHI restriction endonuclease).

In some embodiments Oligo B is ligated to the 5′-terminus of the ssDNA using an RNA Ligase or an ssDNA ligase. Sources of RNA or ssDNA ligase are given above.

In other embodiments, a dsDNA-dependent DNA ligase, such as T4, E. Coli, or Taq DNA ligase, is used to ligate Oligo B to the 5′-terminus of the ssDNA. If a dsDNA-dependent DNA ligase is used, an additional stabilizer oligonucleotide will be required to generate a transient double-stranded region at the juxtaposition of the ssDNA 5′-end and the Oligo B 3′-end. Criteria for the stabilizer oligonucleotide for the Oligo B ligation are the same criteria as for the Oligo A′ ligation (described above), except that the 5′-end of the stabilizer oligonucleotide will be complementary to the 5′-end of the ssDNA, and the 3′-end of the stabilizer oligonucleotide will be complementary to the 3′-end of Oligo B.

As an example, if Oligo B has the structure: HO-5′-GGTAATACGACTCACTATAGG-3′-OH (SEQ ID NO: 3), a typical stabilizer oligonucleotide structure is: HO-5′-NNNNCCTATAGTGAGTCGTATTACC-3′-NH2 (SEQ ID NO: 4)

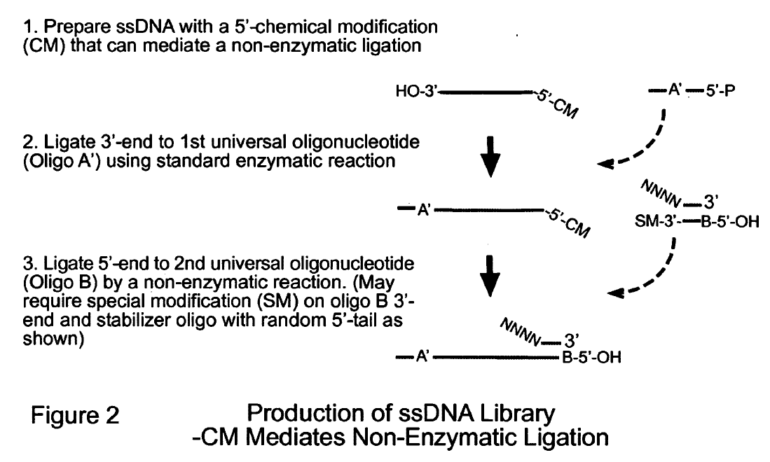

Referring now again to the figures, FIG.2 illustrates an embodiment of the current invention whereby construction of a ssDNA library occurs using a 5′-CM capable of participating in a non-enzymatic ligation.

In one embodiment, a CM that can mediate a specific non-enzymatic ligation of the ssDNA 5′-terminus to the 3′-terminus of an oligonucleotide is disclosed. To be useful, the CM must be easily attached to the 5′-end of the ssDNA, and it must mediate a highly specific ligation reaction between the 5′-terminus of the ssDNA and the 3′-terminus of Oligo B. Several methods for performing non-enzymatic DNA ligations are disclosed in Xu et al, 2001, Nature Biotech. 19, 148-152, which is herein incorporated by reference. A particularly useful class of chemical reactions for the purposes of this invention is reaction of the sulfur atom on a 3′-phosphorothioate with a 5′-bromo, 5′-acetoamido, 5′-tosyl, or 5′-iodo group as disclosed by Gryaznov, S. M. et al, 1994, Nucleic Acids Res. 22, 2366-69 and Herrlein, M. K. et al, 1995, J. Am Chem. Soc. 1 17, 10151-10152; and Xu, Y., and Kool, E. T. 1997, Tetrahedron Letters, 38, 5595-98, all of which are herein incorporated by reference in their entirety. In one embodiment of the current invention the CM on the ssDNA is a 5′-iodo group and Oligo B contains a phosphorothioate on the 3′-terminus. The iodine at the 5′-terminus of the ssDNA reacts with the 3′-phosphorothioate, resulting in loss of the Iodine and covalent bond formation between the sulfur atom on the 3′-terminus of Oligo B and the 5′-carbon on the ssDNA.

In step 1 of one embodiment illustrated in FIG. 2, a population of ssDNA molecules with a 5′-terminal CM that can mediate a non-enzymatic ligation is prepared. Methods for preparation of ssDNA with a 5'terminal CM from RNA and DNA samples are described above. In one embodiment, the ssDNA is prepared by polymerase extension of an oligonucleotide primer containing a 3′-degenerate sequence and a 5′-terminal deoxythymidine with an attached chemical modification selected from the group comprising 5′-iodo, 5′-acetoamido, 5′-tosyl, and 5′-bromo.

In the second step according to one embodiment illustrated in FIG. 2, Oligo A′ is ligated to the 3′-terminus of the ssDNA by a standard enzymatic ligation. Oligo A′ must have a 5′-phosphate group, and it is preferred that the 3′-terminus of Oligo A′ is blocked with a phosphate, amino, dideoxy, or other chemical group. There is no particular limitation on the nucleotide sequence of Oligo A′, so long as Oligo A′ is not complementary to the ssDNA sequences or Oligo B. In some embodiments, Oligo A′ contains the antisense strand of a bacteriophage RNA polymerase promoter such as the promoter sequence for T3, SP6, or T7 bacteriophage. In other embodiments, Oligo A′ contains a recognition site for a restriction endonuclease.

In some embodiments Oligo A′ is ligated to the 3′-terminus of the ssDNA using an RNA ligase or a DNA ligase with activity on single-stranded DNA. T4 RNA ligase is available commercially from a number of companies such as New England Biolabs (Beverly, Mass.). A thermostable single-stranded DNA ligase is also readily commercially available such as from Prokaria (Reykjavik, Iceland).

In other embodiments, Oligo A′ is ligated to the 3′-terminus of the ssDNA by a double-stranded DNA (dsDNA)-dependent ligase, such as T4 DNA Ligase, E. Coli DNA Ligase, or Taq DNA Ligase. Ligation of Oligo A′ to the 3′-terminus of ssDNA with a dsDNA-dependent ligase requires an additional stabilizer oligonucleotide to create a transient double-stranded region at the juxtaposition of Oligo A′ and the 3′-end of the ssDNA. In preferred embodiments, the stabilizer oligonucleotide has 4-30 nucleotides of sequence complementary to Oligo A′ at the 5′-end, and from 1-10 random nucleotides at the 3′-end (see U.S. Patent Application 20030104432, incorporated here in it's entirety for all purposes). The stabilizer oligonucleotide generally has a hydroxyl group at the 5′-terminus and a blocked 3′-end to prevent spurious ligation of the stabilizer oligonucleotide to the other reactants. As an example, if Oligo A′ has the structure: P-5′-CCTTTAGTGAGGGTTAATTCC-3′-NH2 (SEQ ID No: 1 ), a typical stabilizer oligonucleotide structure is: HO-5′-GGAATTAACCCTCACTAAAGGNNNN-3′-NH2 (SEQ ID No: 2 )

In some embodiments, after allowing the ligation reaction with Oligo A′ to proceed for a certain period of time, the ligation mixture is treated with a phosphatase enzyme. Treatment with the phosphatase remove potentially reactive 5′-phosphates from the 5′-terminus of unligated Oligo A′, blocking any further ligation from occurring. Useful phosphatases include calf intestinal alkaline phosphatase, and arctic shrimp alkaline phosphatase, all of which are available commercially. Following treatment with phosphatase, the ssDNA (ligated to Oligo A′) may be purified by any of the common DNA purification methods well-known in the art and commercially available.

Referring now again to FIG. 2 according to one embodiment of the current invention, Oligo B and the ssDNA are next ligated under conditions in which Oligo A′ can not undergo further ligation (step 3). In this preferred embodiment, Oligo B is ligated to the 5′-terminus of the ssDNA using a non-enzymatic ligation. The non-enzymatic reaction used is primarily dependent on the nature of the CM on the 5′-end of the ssDNA. The reaction of the 3′-end of Oligo B with the CM-modified 5′-end of the ssDNA must be highly favored in comparison to ligation of the Oligo B 3′-end with the 5′-end of Oligo A′. An example of such a highly favored reaction is where ligation of Oligo B to the ssDNA is 1,000 times more efficient then ligation of Oligo B to Oligo A′. However, any non-enzymatic ligation that highly favors the ligation of Oligo B to the ssDNA over the ligation of Oligo B to Oligo A′ is useful for the method of the invention.

In some embodiments of the process described in FIG. 2, step 3, the ligation reagents used to ligate Oligo A′ are removed from the Oligo A′-ssDNA molecules, prior to ligation of Oligo B. The reagents that must be removed will depend on the reaction conditions used for ligation of Oligo A′, as well as the conditions to be used for ligation of Oligo B. In some embodiments, there are no reagents from ligation of Oligo A′ that will interfere with ligation of Oligo B. General methods of purification of DNA fragments, all of which are well known in the art, such phenol/ chloroform extraction followed by ethanol precipitation, affinity purification on a glass bead matrix, or size exclusion chromatography on sephacryl-S300, will usually be adequate to remove ligase enzymes, ATP, and other constituents of the Oligo A′ ligation reaction.

Oligo B, as used in FIG. 2 step 3, can contain any nucleotide sequences that are not complementary or identical to sequences making up Oligo A′ or the ssDNA. In some embodiments Oligo B contains an RNA polymerase promoter sequence, such as the promoter sequence of the SP6, T7, or T3 bacteriophage RNA polymerase. In some embodiments Oligo B contains restriction endonuclease recognition sites.

In a preferred embodiment, the 5′ CM on the ssDNA is an iodine atom, and Oligo B contains a 3′-phosphorothioate. It is preferred, but not required, that the 5′-end of Oligo B is terminated in a 5′-OH group. In one preferred embodiment, ligation is conducted in 20 ul of an aqueous solution of 10 mM MgCl₂, 10 mM Tris-Acetate (pH 7.0). Included in the reaction mixture are the 5′-iodo modified ssDNA, 200 pMoles of Oligo B (3′-phosphorothioate-modified) and 200 pMoles of a stabilizer oligonucleotide. The reaction is incubated for two hours at 25° C.

The additional stabilizer oligonucleotide improves the efficiency of the non-enzymatic reaction by creating a transient double-stranded region at the juxtaposition of the ssDNA 5′-end and the Oligo B 3′-end. Criteria for the stabilizer oligonucleotide for the Oligo B ligation are the same criteria as for the Oligo A′ ligation (described above), except that the 5′-end of the stabilizer oligonucleotide will be complementary to the 5′-end of the ssDNA, and the 3′-end of the stabilizer oligonucleotide will be complementary to the 3′-end of Oligo B. As an example, if the 5′-terminal nucleotide of the ssDNA contains a deoxythymidine, and the rest of the ssDNA sequence is random, Oligo B has the structure: HO-5′-GGTAATACGACTCACTATAGG-3′-PSO₃ (SEQ ID NO: 3). A typical stabilizer oligonucleotide structure is: HO-5′-NNNNACCTATAGTGAGTCGTATTACC-3′-NH2 (SEQ ID NO: 4)

There are many possible variations of the preferred embodiment shown in FIG. 2. In some embodiments, the order of ligation is reversed such that the 5′-terminus of the ssDNA is first ligated to Oligo B by a non-enzymatic ligation, the buffer is changed, and then Oligo A′ is ligated to the 3′-terminus of the ssDNA. In other embodiments, Oligo A′ and Oligo B are ligated to the 3′-terminus and 5′-terminus of the ssDNA, respectively, in a single reaction mixture.

In other embodiments of the process disclosed in FIG. 1 or FIG. 2, Oligo B contains a 5′-PC-biotin. After ligation of Oligo B to the 5′-terminus of the ssDNA, the PC-biotin mediates binding of the ssDNA library to a streptavidin-coated solid support, and contaminates such as residual unligated Oligo A′ are washed away. The library can then be released from the solid support by irradiation with UV-B light.

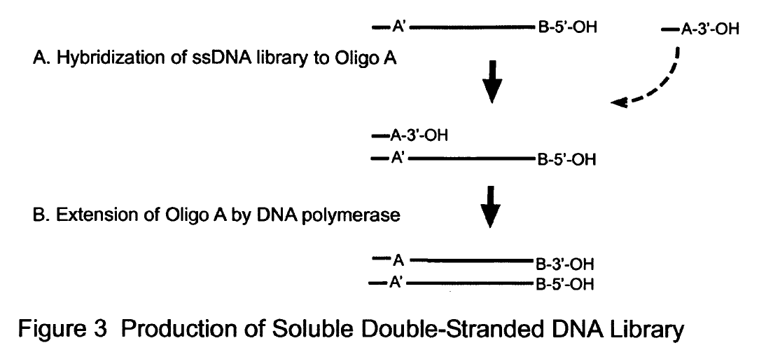

Referring now again to the figures, FIG. 3 illustrates the preparation of a double-stranded DNA library according to an embodiment of the present invention. In this embodiment, the ssDNA library generated according to the current invention is further hybridized to an oligonucleotide (Oligo A), which is the reverse complement of Oligo A′, and Oligo A is extended by DNA synthesis with a DNA polymerase.

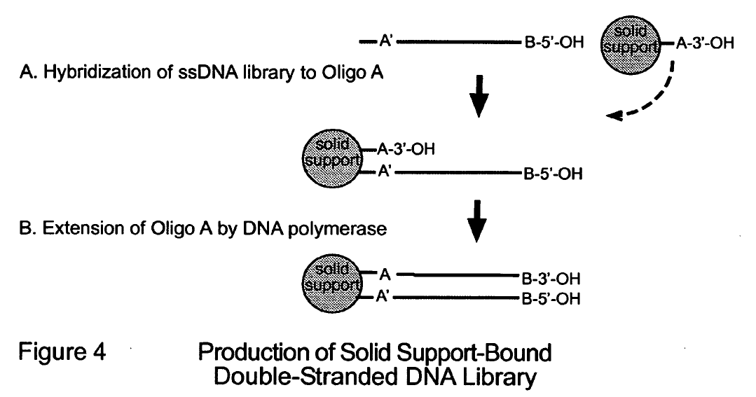

Referring now again to the figures, FIG. 4 illustrates the preparation of a solid support-bound double-stranded DNA library according to a preferred embodiment of the invention. In this embodiment, a completed ssDNA library, prepared according to a method of the present invention, is hybridized to a solid support-bound oligonucleotide (Oligo A), that is complementary to Oligo A′. After hybridization, the Oligo A primer is extended by a DNA polymerase.

In some embodiments, the solid support-bound DNA library disclosed in FIG. 4 is archived by desiccation and storage of the solid supports (e.g., in a sealed container stored in a drawer, cabinet, refrigerator, or freezer, or other frozen storage device). In other embodiments the solid support-bound DNA library disclosed in FIG. 4 is archived by suspension of the solid support(s) in an aqueous solution or a solvent and storage in a sealed container. In other embodiments, the solid support is already contained in a device (i.e. a microtiter plate, microfluidic cartridge, filtration plate, fluidic cartridge and the like), the solid support bound DNA library is archived by desiccation or suspension in an aqueous buffer or non-aqueous solvent, and the device is stored for later use.

One with skill in the art will know how to prepare additional RNA or DNA copies of the nucleic acids comprising the library without depleting the DNA library archived on the solid support(s). For example, a solid support-bound library can be retrieved from storage, suspended in a reaction buffer, and additional soluble copies of the library can be prepared by repeated rounds of DNA synthesis (e.g. denaturation, annealing, extension) primed by an oligonucleotide containing the sequence of Oligo B. In another example, the Oligo B sequence contains a bacteriophage promoter sequence, the solid support-bound library can be recovered from storage and suspended in transcription buffer, and RNA copies of the library can be prepared by in vitro transcription. After production of additional RNA or DNA copies, the solid support(s) containing the bound DNA library can be washed and returned to the archived condition.

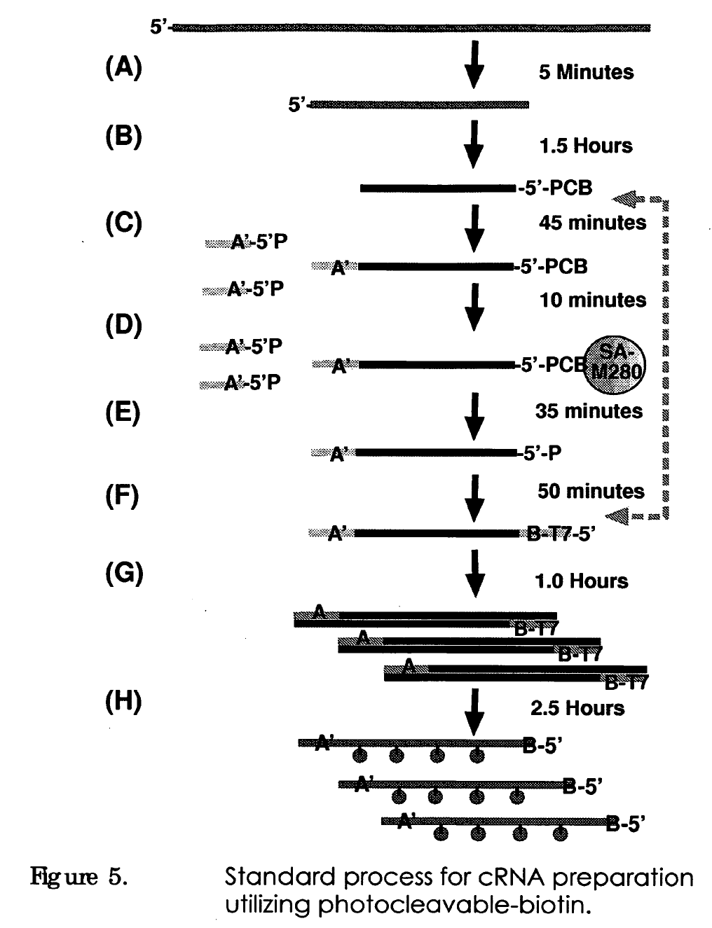

Referring now again to the figures, FIG. 5 illustrates a process of cRNA preparation utilizing photocleavable-biotin according to one embodiment of the present invention. RNA template is first heated in the presence of magnesium to effect random cleavage of the RNA (A). Next, reverse transcription is conducted using a random hexamer with an attached 5′-photocleavable biotin (PCB) (B). Then in a series of steps (C-F) unique linkers are added to each end of the single-stranded cDNAs. Finally, the single-stranded library is amplified by PCR (G) and transcribed by T7 or SP6 polymerase in the presence of biotinylated nucleotides to produce labeled cRNA (H). A potential advantage of the process is the combination of random fragmentation and random-priming that may provide better conversion of the transcriptome to cDNA. Other advantages are the lack of a second strand synthesis reaction, and the potential to produce exclusively sense or antisense cRNA depending on bacteriophage promoter inclusion in Linker A′ or Linker B. Purification of the cDNA after the 1^{st} linker ligation by affinity binding to streptavidin-coated beads provides efficient removal of Linker A′, preventing unwanted ligation of Linker A′ to Linker B.

As a separate embodiment of the current invention, It is possible to replace steps C-F of FIG. 5 with a one step combination non-enzymatic ligation of Linker B and enyzymatic ligation of Linker A′ to cDNA. That step reduces process time significantly and eliminate any direct joining between A′ and B linkers.

Kits for Carrying Out the Invention Process

Kits are provided for carrying out the method of the invention in diagnostic, forensic, research, environmental monitoring, and other applications. Such kits can include any or all of the following: assay reagents, buffers, specific nucleic acids, antibodies, oligonucleotides, hybridization probes, oligonucleotide primers, chemically-modified oligonucleotides, chemical reagents, enzymes, proteins, solid supports (e.g. filter membranes, beads, tubes, microtiter plates, reaction chambers, nanoparticles), nucleic acid purification columns and devices, and the like. Additionally the kit may contain a cartridge(s) for carrying out the processes of the invention including: microfluidic cartridges, fluidic cartridges, or sets of reaction chambers contained in a unit device.

In addition, the kits can include instructional materials containing directions (i.e., protocols) for the practice of the methods of this invention. While the instructional materials typically comprise written or printed materials they are not limited to such. Any medium capable of storing such instructions and communicating them to an end user is contemplated by this invention. Such media include, but are not limited to electronic storage media (e.g., magnetic discs, tapes, cartridges, chips), optical media (e.g., CD ROM), and the like. Such media may include addresses to internet sites that provide such instructional materials.

The present invention also provides for kits for preparing DNA libraries by the method of the invention. Such kits can be prepared from readily available materials and reagents. For example, such kits can comprise one or more of the following materials: RNA fragmentation buffer, DNA fragmentation buffer, chemically-modified and regular oligonucleotide primers, reagents for chemical coupling, chemical compounds, reagent and devices for nucleic acid purification (columns, purification cartridges, filters), enzyme reaction buffers, dNTPs, NTPs, other enzyme co-factors and reagents, reverse transcriptase, DNA polymerase, ligase, RNase inhibitor, other enzymes, universal oligonucleotides, stabilizer oligonucleotides, solid supports ((e.g. filter membranes, beads, tubes, microtiter plates, reaction chambers, nanoparticles), reaction tubes, and instructions for construction of single-stranded and double-stranded DNA libraries.

A wide variety of kits and components can be prepared according to the present invention, depending upon the intended user of the kit and the particular needs of the user. Diagnostic applications would typically involve preparing a DNA library from a clinical sample, amplifying the library, and monitoring the absolute or relative abundance of a plurality of nucleic acid sequences in the amplified library, by microarray hybridization, sequencing, real-time PCR, and other assay methods. Research applications would typically involve preparing a DNA library or DNA libraries from any type of biological sample(s), amplifying the library or libraries, and characterizing the nucleic sequence make-up of the library, typically by sequencing, microarray hybridization, real-time or regular PCR, or assay of DNA polymorphisms. Environmental monitoring applications would typically involve preparing a DNA library from an environmental sample (e.g. soil, water, wastewater, sewage, sludge, air samples), amplifying the library, and monitoring the absolute or relative abundance of a plurality of nucleic acid sequences in the amplified library, by microarray hybridization, sequencing, real-time PCR, and other assay methods. Forensic applications would typically involve preparing a DNA library from a forensic sample (i.e. blood spot, hair, clothing, evidence swabs), amplifying the library, and performing an analysis of known DNA polymorphisms at specific genetic loci represented in the library.

### EXAMPLE 1

### Library Construction from Template RNA

The following is an example of how library construction from template RNA could be performed according to an embodiment of the present invention.

Oligonucleotides: All oligonucleotides are obtainable from Integrated DNA Technologies. Oligonucleotide R-PC is a random hexamer with a photocleavable biotin group (PC-biotin) attached to the 5′-terminus and a 3′-hydroxyl group. It is used to prime reverse transcription. The sequence of R-PC is 5′-NNNNNN-3′ (SEQ ID NO:5).

Oligonucleotide B-1 has a 5′-hydroxyl group, a 3′-hydroxyl, and contains the T7 bacterophage promoter sequence (underlined). It is used for ligation to the 5′-terminus of single stranded cDNA. The sequence of B-1 is 5′-GGTAATACGACTCACTATAGG-3′ (SEQ ID NO:6).

Oligonucleotide A′-1 has a 5′-phosphate group, a 3′-amino group and contains the reverse complement of the T3 bacteriophage promoter sequence (underlined). It is used for ligation to the 3′-terminus of single-stranded cDNA. Note that the 5′-phosphate group mediates ligation to the 3′-terminus of single-stranded cDNA molecules, while the 3′-amino blocks un-wanted self-ligation of the oligonucleotide. The sequence of A′-1 is 5′-CCTTTAGTGAGGGTTAATTCC-3′ (SEQ ID NO:7).

Oligonucleotide T10A-1 has a 5′-amino group, a 3′-hydroxyl group and contains the reverse complement of oligonucleotide A′-1. It is used for hybridization and capture of completed ssDNA library. The sequence of T10A-1 is 5′-TTTTTTTTTTGGAATTAACCCTCACTAAAGG-3′ (SEQ ID NO:8).

Fragmentation of RNA: One hundred nanograms (100 ng) of rat liver mRNA, suspended in 10 ul of double-distilled water is combined with a 2.5 ul aliquot of 5× fragmentation buffer (200 mM tris-acetate pH 8.1, 500 mM potassium acetate, 150 mM magnesium acetate) in a 0.2 ml thin-wall polypropylene tube. The mixture is heated to 80° C. for three minutes and then chilled on ice. The tube is centrifuged at 3,000 g for 15 seconds to collect any condensate at the bottom. The fragmented RNA is purified on a Micro-Spin G50 spin column according to the manufacturer's recommendations (GE Healthcare, Chalfont St. Giles, United Kingdom). The column eluate is concentrated to a volume of 8 ul by vacuum evaporation.

Reverse Transcription: Two microliters (2 ul) of 100 uM R-PC oligonucleotide is mixed well with the 8 ul of fragmented RNA from above in a 0.2 ml thin wall polypropylene tube. The mixture is heated for 10 minutes at 70° C., then cooled on ice. The tube is centrifuged at 3,000 g for 15 seconds to collect any condensate at the bottom. To the mixture, is added 10 ul of a reagent solution containing 100 mM Tris-Cl pH 8.3, 150 mM KCl, 6 mM MgCl₂, 1 mM dATP, 1 mM dCTP, 1 mM dGTP, 1 mM dTTP, 20 u/ul Superscript II reverse transcriptase (Invitrogen, Carlsbad, Calif.) and 4 u/ul RNase Out (Invitrogen). The reagent solution, RNA and R-PC primer is mixed well, then incubated at 45° C. for one hour.

Purification of ssDNA: To degrade RNA template, 20 ul of 0.5 N NaOH, 0.25 M EDTA solution is added to the reaction tube (above), and the mixture is incubated at 65° C. for 20 minutes. To neutralize, an additional 40 ul of a solution containing 0.5 M Tris-Cl pH 7.5, 0.25 N HCl, 0.1% Tween-20, is added to the tube. The tube is vortexed briefly and centrifuged at 3,000 g for 15 seconds in order to mix all components well. The single-stranded DNA is purified using the Qiaquick PCR Purification Kit according to the manufacturer's instruction (Qiagen, Valencia, Calif.).

Capture of ssDNA: Two hundred fifty micrograms (250 ug) of M280 Streptavidin Dynabeads (Invitrogen Corp, Carlsbad, Calif.) are pre-washed according to the manufacturer's instructions. The beads are resuspended in a 1.5 ml microfuge tube in 100 ul of a solution containing 10 mM Tris-Cl pH 7.5,1 mM EDTA, 0.1% Tween-20, and 2 M NaCl. The purified ssDNA (80 ul) is added to the beads, and the mixture is incubated at room temperature for 15 minutes with moderate agitation. The beads are washed twice with a solution containing 10 mM Tris-Cl pH 7.5,1 mM EDTA, 0.1% Tween-20, and 1 M NaCl. The beads are washed twice with a solution containing 10 mM Tris-Cl pH 7.5,1 mM EDTA, 0.1% Tween-20. Residual liquid is removed from the beads and they are stored on ice for 15 minutes.

Ligation of Oligo A′: Fifty (50) picomoles of oligonucleotide A′-1 are suspended in 50 ul of a solution containing 50 mM Tris-Cl pH 7.6,10 mM MgCl₂, 1 mM ATP, 10 mM DTT, and 7.5% PEG 6,000. The mixture containing A′-1 is combined with the beads with the attached ssDNA (above). Fifty units of T4 RNA Ligase (New England Biolabs, Beverly, Mass.) is added to the bead suspension, and the suspension is incubated at 37° C. for 2 hours with moderate agitation. Following the incubation, the beads are washed four times with 200 ul of a solution containing 10 mM Tris-Cl pH 7.5,1 mM EDTA, 0.1% Tween-20, then the beads are suspended in 50 ul of a solution containing 50 mM Tris-Cl pH 7.6, 10 mM MgCl₂, 1 mM ATP, 10 mM DTT, and 7.5% PEG 6,000.

Removal of PC-Biotin: The resuspended beads, in a 1.5 ml microfuge tube, are incubated for 10 minutes under a Model XX-40 UV-A lamp (Spectroline, Westbury, N.Y.) delivering approximately 1800 uW/cm2 of 365 nM UV light, while rotating on a Labquake tube rotator.

Ligation of Oligo B: The solution (50 ul) containing the released ssDNA is removed from the beads and transferred to a new 1.5 ml microfuge tube. Fifty (50) pmoles of oligonucleotide B-1 and 50 units of T4 RNA ligase are added to the tube. The contents of the tube are thoroughly mixed and incubated for 2 hours at 37° C. The mixture is heated for 15 minutes at 65° C. to inactivate the ligase.

Library Capture: Oligonucleotide T10A-1 is covalently attached to Dynabeads M-270 Carboxylic Acid (Invitrogen, Carlsbad, Calif.) according to the manufacturer's instructions. 250 ug of T10A-1 coupled M270 beads are pre-washed twice with 200 ul of a solution containing 10 mM Tris-Cl pH 7.5, 1 mM EDTA, 0.1% Tween-20, and 2 M NaCl, then resuspended in 50 ul of the same solution. The ligation product from above (˜53 ul) is combined with the washed beads, and the mixture is incubated for 15 minutes at 50° C. The beads are washed twice at 50° C. temperature with 200 ul of a solution containing 10 mM Tris-Cl pH 7.5, 1 mM EDTA, 0.1 %Tween-20, and 1 M NaCl. The beads are washed twice at room temperature with 100 ul of a solution containing 10 mM Tris-Cl pH 8.8, 1 mM EDTA, 0.1% Tween-20, and 5 mM MgCl₂. Residual liquid is removed from the beads and they were stored on ice.

Synthesis of Complementary Strand: The beads are resuspended in 50 ul of a solution containing 20 mM Tris-Cl pH 8.8, 10 mM (NH₄)₂SO₄, 10 mM KCl, 2 mM MgSO₄, 0.1% Triton X-100, 200 uM dATP, 200 uM dCTP, 200 uM dGTP, 200 uM dTTP, and 16 units of Bst I Polymerase Large Fragment (New England Biolabs, Beverly, Mass.). The mixture is incubated for 15 minutes at 37° C., followed by 15 minutes at 65° C. The beads are washed four times with 100 ul of 10 mM Tris-Cl pH 7.5, 1 mM EDTA, 0.1% Tween-20, and 100 mM NaCl. The beads with attached double-stranded library are stored at −70° C.

### EXAMPLE 2

### Library Construction from Double-Stranded DNA Template

The following is an example, according to one embodiment of the present invention, of how library construction from double-stranded DNA template oligonucleotides could be performed. Oligonucleotides used are the same as for Example I (above).

Depurination of DNA: One hundred nanograms (100 ng) of rat liver genomic DNA is dissolved in 10 ul of 10 mM Tris-Cl pH 7.5, 0.1 mM EDTA and heated to 95° C. for 5 minutes in an 0.2 ml polypropylene tube. The DNA is snap-cooled on wet ice.

Synthesis of ssDNA: Ten microliters (10 ul) of a mixture containing 40 mM Tris-Cl pH 8.8, 20 mM (NH₄)₂SO₄, 20 mM KCl, 4 mM MgSO₄, 0.1 %Triton X-100, 400 uM dATP, 400 uM dCTP, 400 uM dGTP, 400 uM dTTP, and 20 uM R-PC oligonucleotide is added to the depurinated DNA. 16 units of Bst I DNA polymerase in a volume of 2 ul is added to the mixture. The tube containing fragmented DNA, reagent mixture, and Bst I polymerase is incubated for 15 minutes at 37° C. followed by 15 minutes at 65° C. DNA is purified using the Qiaquick PCR Purification Kit according to the manufacturer's instruction (Qiagen, Valencia, Calif.).

Capture of ssDNA: Two hundred fifty micrograms (250 ug) of M280 Streptavidin Dynabeads (Invitrogen Corp, Carlsbad, Calif.) is pre-washed according to the manufacturer's instructions. The beads are resuspended in a 1.5 ml microfuge tube in 100 ul of a solution containing 10 mM Tris-Cl pH 7.5, 1 mM EDTA, 0.1% Tween-20, and 1 M NaCl. The ssDNA from above (22 ul), is combined with the beads, and the mixture is incubated at room temperature for 15 minutes with moderate agitation. The beads are washed once with 200 ul of a solution containing 10 mM Tris-Cl pH 7.5, 1 mM EDTA, 0.1% Tween-20, and 1 M NaCl. The beads are washed twice with 200 ul of a solution containing 10 mM Tris-Cl pH 7.5, 1 mM EDTA, 0.1% Tween-20.

Removal of template DNA: The beads are resuspended in 200 ul of a solution containing 25 mM NaOH, 1 mM EDTA, 0.1% Tween-20, and incubated at room temperature for 15 minutes with moderate agitation. The beads are washed once with 200 ul of a solution containing 25 mM NaOH, 1 mM EDTA, 0.1% Tween-20. The beads are washed twice with 200 ul of a solution containing 500 mM Tris-Cl pH 7.5, 1 mM EDTA, and 0.1% Tween-20. The beads are washed twice with 100 ul of a solution containing 10 mM Tris-Cl pH 7.5, 1 mM EDTA, 0.1% Tween-20. Residual liquid is removed from the beads and they are stored on ice for 15 minutes.

Generation of Double-Stranded DNA Library from ssDNA: To generate a bead-bound double-stranded DNA library, the remaining steps in Example 1 are followed, including the sections entitled: Ligation of Oligo A′, Removal of PC-Biotin, Ligation of Oligo B, Library Capture, and Synthesis of Complementary Strand.

### EXAMPLE 3

### Preparation of Biotinylated Complementary RNA Suitable for Microarray Hybridization

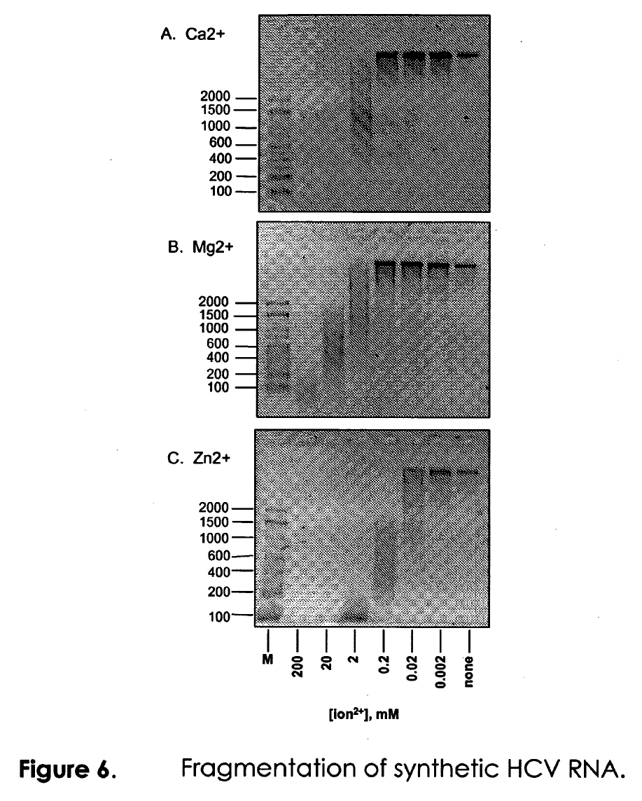

An 8.5 kb in vitro-transcribed RNA derived from the Hepatitis C virus (HCV) genome was initially used for optimization of key steps in ORB-AMP™. To test conditions for template fragmentation, the 8.5 kb RNA was heated to 83° C. for 3 minutes in the presence of calcium, magnesium, or zinc cations. Fragments were prepared using the acetate salts of each cation at concentrations ranging from 0.002 mM to 200 mM (FIG. 6, A-C). Heating in the presence of any of these cations resulted in uniform smears of degraded RNA, suggesting that cleavage of the RNA was random or semi-random. The concentrations of calcium and magnesium cations required for fragmentation of the HCV transcript were similar. Heating in 2 mM calcium or magnesium completely eliminated the original 8.5 kb band, and heating in 20 mM of the cations produced RNA fragments averaging 700 nucleotides or less in size (FIG. 6, A-B). In contrast, zinc ions promoted HCV RNA fragmentation at concentrations that were approximately 100-fold lower than those of magnesium and calcium ions (FIG. 6C). Further evaluation showed that incubation of 30-50 nanograms RNA template in 3 mM magnesium acetate for 5 minutes at 86 C fragmented the 8.5 kb RNA to an average size of 800 nucleotides, and this was chosen as a standard condition (not shown).

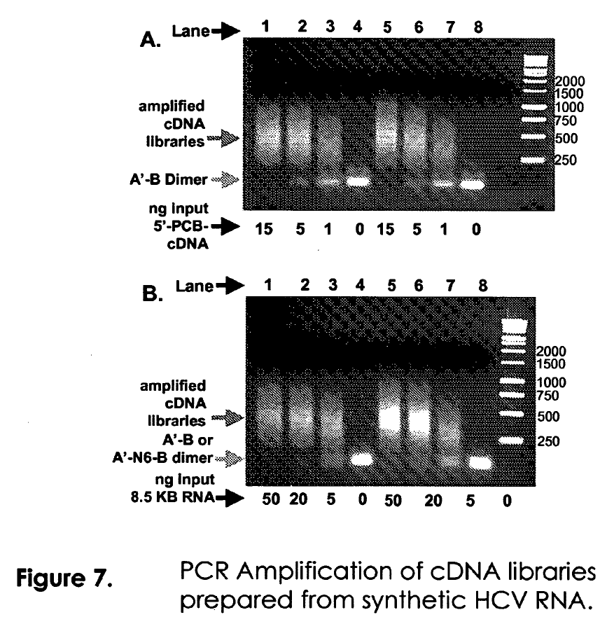

Additional standard conditions for the linker ligation and subsequent PCR amplification were derived using the 8.5 kb synthetic RNA as template. In order to obtain a high yield of amplified library containing a good size distribution of cDNA inserts it is necessary to minimize any carrier over of linker A′ in to the second ligation. An optimized wash protocol for SA-coated beads containing bound cDNA yielded very little carry-over of linker A′. FIG. 7A shows amplification products from an experiment in which 20, 5 or 1 nanogram aliquots of PCB-labeled cDNA were ligated to 100 pMoles of Linker A′ and bound to SA-coated beads, the beads were washed with an optimized protocol, irradiated with 365 nm UV light, then the released cDNA was ligated to 100 pMoles Linker B. Molecules of cDNA with attached A′ and B linkers were then amplified by PCR. Very little dimer product resulting from ligation of Linker A′ to Linker B was observed in lanes 2 and 6 in which only 5 nanograms of cDNA were used (FIG. 7A), indicating that binding the PCB-cDNA to the SA-coated beads and subsequent washing of the beads was surprisingly effective in removing un-ligated linker A′.

To insure high yield of pure amplified library it is also necessary to minimize carry-over of free reverse-transcription primer in to the first linker ligation. This is because the reverse transcription primer can react with both Linker A′ and Linker B to form a dimer of structure A′-N6-B. FIG. 7B shows that as little a 20 nanograms of RNA template can be used as input without generation of appreciable dimer as observed in the PCR reaction product. Note that at least 70% pure amplified cDNA library can be generated from only 5 nanograms of template RNA (FIG. 7B), and this has also been observed with just 2 nanograms input RNA (not shown). In the standard protocol MinElute column purification (Qiagen) is used to clean up the cDNA prior to ligation to linker A′. Note that adding an additional Sephacryl-300 mini-spin column purification after the cDNA synthesis did not improve the purity of the amplified library (FIG. 7B, compare lanes 4-7 with 1-3). Multiple parameters such as cDNA purification method, reverse transcriptase used, and input primer concentration, can still be evaluated to improve the purity and yield of cDNA and therefore the purity of the amplified library from low input amounts of RNA.

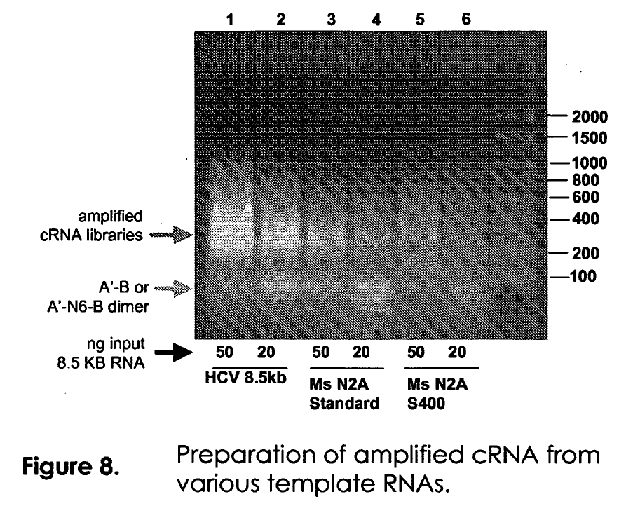

To confirm that amplified cDNA libraries could be converted to complementary RNA by in vitro transcription, A Mouse N2A cell total RNA sample was pre-treated with the RiboMinus Kit (Invitrogen) to reduce ribosomal RNA, then 50 and 20 nanograms aliquots were converted to single-stranded cDNA, adapted with Linker A′ and B, amplified by PCR, and transcribed with SP6 RNA polymerase. Note that the SP6 bacteriophage promoter consensus sequence was included in the sequence of Linker B. Twenty cycles of PCR and a 2 hour in vitro transcription reaction at 37 C yielded over 100 micrograms of cRNA per sample (not shown), representing over 50,000-fold amplification. Formaldehyde-agarose gel electrophoresis of reaction products revealed that 60-80% of the amplified cRNA consisted of a smear ranging in size from 100 to 600 nucleotides, with the balance consisting of amplified dimer product (FIG. 8).

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A process for constructing a single-stranded DNA library, comprising the steps of:
(a) preparing a single-stranded DNA having a 5′ end and a 3′ end wherein, a photocleavable biotin is attached to said 5′-end;
(b) ligating a first universal oligonucleotide to said 3′ end of said single-stranded DNA;
(c) providing a solid support, wherein said photocleavable biotin mediates binding of said single-stranded DNA to said solid support;
(d) removing unligated first universal oligonucleotide;
(e) detaching said photocleavable biotin from said 5′ end; and
(f) ligating a second universal oligonucleotide to said 5′ end of said single-stranded DNA to form a single-stranded DNA library.

2. The process of claim 1, wherein said preparing step is performed by enzymatic extension of an oligonucleotide primer containing a photocleavable-biotin.

3. The process of claim 2, wherein said enzymatic extension comprises reverse transcription of an RNA template.

4. The process of claim 2, wherein said enzymatic extension comprises DNA polymerase extension of a DNA template.

5. The process of claim 3, wherein said oligonucleotide primer comprises a degenerate sequence selected from the group consisting of a random nucleotide sequence, a poly-deoxyinosine nucleotide sequence, and a nucleotide sequence containing both random nucleotides and deoxyinosine nucleotides.

6. The process of claim 4, wherein said oligonucleotide primer comprises a degenerate sequence selected from the group consisting of a random nucleotide sequence, a poly-deoxyinosine nucleotide sequence, or a nucleotide sequence containing both random nucleotides and deoxyinosine nucleotides.

7. A process for constructing a single-stranded DNA library, comprising the steps of:
(a) preparing a single-stranded DNA having a 5′ end and a 3′ end, wherein said 5′ end contains a chemical modification selected from the group consisting of a 5′-bromo, 5′ acetoamido, 5′-tosyl, and 5′-iodo;
(b) ligating a first universal oligonucleotide to said 3′ end of said single-stranded DNA in an enzymatic reaction; and
(c) ligating a second universal oligonucleotide to said 5′ end of said single-stranded DNA in a non-enzymatic reaction, wherein said chemical modification mediates said non-enzymatic reaction at said 5′ end to form a single-stranded DNA library.

8. The process of claim 7, wherein said preparing step is performed by an enzmatic extension of an oligonucleotide primer containing a chemical modification selected from the group comprising a 5′-bromo, 5′-acetoamido, 5′-tosyl, and 5′-iodo.

9. The process of claim 8, wherein said enzymatic extension comprises reverse transcription of an RNA template.

10. The process of claim 8, wherein said enzymatic extension comprises DNA polymerase extension on a DNA template.

11. The process of claim 9, wherein the sequence of said oligonucleotide primer comprises a 3′ degenerate sequence and a 5′-terminal deoxythymidine.

12. The process of claim 10, wherein the sequence of said oligonucleotide primer comprises a 3′ degenerate sequence and a 5′-terminal deoxythymidine.

13. The process of claim 11, wherein said 3′ degenerate sequence is selected from the group consisting of a random nucleotide sequence, a poly-deoxyinosine nucleotide sequence, and a nucleotide sequence containing both random and deoxyinosine nucleotides.

14. The process of claim 12, wherein said 3′ degenerate sequence is selected from the group consisting of a random nucleotide sequence, a poly-deoxyinosine nucleotide sequence and a sequence containing both random and deoxyinosine nucleotides.

15. The process of claim 7, wherein said ligating step (b) occurs simultaneously with ligating step (c).

16. A kit for constructing a single-stranded DNA library, comprising: a reagent and instructions for enabling use of said kit according to the process of claim 1.

17. A kit for constructing a single-stranded DNA library, comprising: a reagent and instructions for enabling use of said kit according to the process of claim 7.

18. A kit for constructing a single-stranded DNA library, comprising: a reagent and instructions for enabling use of said kit according to the process of claim 15.

19. A process for constructing a single-stranded DNA library, comprising the steps of:
(a) preparing a single-stranded DNA having a 5′ end and a 3′ end wherein, a photocleavable biotin is attached to said 5′-end;
(b) ligating a first universal oligonucleotide to said 3′ end of said single-stranded DNA;
(c) providing a solid support, wherein said photocleavable biotin mediates binding of said single-stranded DNA to said solid support;
(d) removing unligated first universal oligonucleotide;
(e) detaching said photocleavable biotin from said 5′ end; and
(f) ligating a second universal oligonucleotide having a nucleotide sequence comprising a bacteriophage RNA polymerase promoter sequence to said 5′ end of said single-stranded DNA to form a single-stranded DNA library.

20. The method of claim 19 further comprising the steps of:
(a) amplifying said single stranded DNA library by polymerase chain reaction to produce an amplified DNA library; and,
(b) transcribing said amplified DNA library with a bacteriophage RNA polymerase to produce an RNA copy of said single-stranded DNA library.


SEQUENCE LISTING (8 sequences)

SEQ ID NO: 1 - DNA, 21 bp, artificial sequence
  oligonucleotide
cctttagtgagggttaattcc

SEQ ID NO: 2 - DNA, 25 bp, artificial sequence
  oligonucleotide
  misc_feature (22)..(25): n = a, c, t, or g
ggaattaaccctcactaaaggnnnn

SEQ ID NO: 3 - DNA, 21 bp, artificial sequence
  oligonucleotide
ggtaatacgactcactatagg

SEQ ID NO: 4 - DNA, 26 bp, artificial sequence
  oligonucleotide
  misc_feature (1)..(4): n=a,c,t, or g
nnnnacctatagtgagtcgtattacc

SEQ ID NO: 5 - DNA, 6 bp, artificial sequence
  oligonucleotide
  misc_feature (1)..(6): n=a, t, c or g
nnnnnn

SEQ ID NO: 6 - DNA, 21 bp, artificial sequence
  oligonucleotide
ggtaatacgactcactatagg

SEQ ID NO: 7 - DNA, 21 bp, artificial sequence
  oligonucleotide
cctttagtgagggttaattcc

SEQ ID NO: 8 - DNA, 31 bp, artificial sequence
  oligonucleotide
ttttttttttggaattaaccctcactaaagg